(19) United States
(12) Patent Application Publication
(10) Pub. No.: US 2024/0253174 A1
(43) Pub. Date: Aug. 1, 2024

(54) ON-DEMAND REPAIR OF MOBILE DEVICE SCREENS

(71) Applicant: RED WOLF TECHNOLOGY, INC., Salt Lake City, UT (US)

(72) Inventors: Bradley Bacigalupi, Lehi, UT (US); Kenneth Scott Dayley, American Fork, UT (US)

(21) Appl. No.: 18/577,210

(22) PCT Filed: Jul. 6, 2022
(86) PCT No.: PCT/US22/73471

§ 371 Date: Jan. 5, 2024

Related U.S. Application Data
(60) Provisional application No. 63/331,565, filed on Apr. 15, 2022.
(60) Provisional application No. 63/218,624, filed on Jul. 6, 2021.

(51) Int. Cl. B24B 27/033; G05B 19/18; G05B 19/414

(52) U.S. Cl. CPC B24B 27/033; G05B 19/182; G05B 19/4145

(57) ABSTRACT

Techniques for polishing and repairing a device's surface are disclosed. An applicator is coated with a paste using a CNC machine. The applicator is attached to a candle bit of the CNC machine, and a device is disposed on a staging area of the CNC machine. The applicator and/or the staging area are moved using the CNC machine to position the applicator above a selected area of the surface of the device. The applicator is rotated at a predetermined rate using the CNC machine. The applicator and/or the staging area are moved using the CNC machine to cause the applicator to contact the surface. The applicator and/or the staging area are moved using the CNC machine in accordance with a predetermined pattern, which is selected to enable the paste and the applicator to polish the surface of the device, including a scratch on the surface.

### CROSS-REFERENCE TO RELATED APPLICATIONS

This application is a nationalization of PCT/US22/73471, filed Jul. 6, 2022, which claims priority to (1) U.S. Provisional Application No. 63/218,624 filed on Jul. 6, 2021, entitled “On-Demand Repair of Mobile Device Screens,” and (2) U.S. Provisional Application No. 63/331,565 filed on Apr. 15, 2022, entitled “On-Demand Repair of Mobile Device Screens,” the entirety of each of which is incorporated herein by specific reference.

### BACKGROUND

Mobile device technology has significantly improved in the past few years. For example, smart phones are now capable of providing new and advanced features that significantly improve users' lives, including work life and personal life. Tablets are also now competing with laptops in terms of practicality and use. Mobile devices, including any type of mobile phone, watch, tablet, laptop, and so on, are also quite expensive. As such, new technologies are emerging in an effort to better protect these costly devices.

As an example, existing technologies are in place to protect the outside of a mobile device, such as via use of a phone cover. Some technologies also exist to protect the screens of devices. For example, a screen protector can be applied to a mobile phone's screen in order to help protect the screen from scratches and, potentially, even from cracking. Screen protectors operate by placing a substance on the top of the screen. That substance is designed to absorb harmful effects that could damage the screen.

Just a few years ago, the availability of different types of mobile devices was generally quite limited. At that time, retailers could store up an inventory of screen protectors, and the chances of that inventory being used was quite high. In recent years, however, the number of new devices is increasing on almost a daily basis. Now, there are thousands of new devices entering the market. Traditional practices of storing inventory specific to particular devices are now cost-prohibitive.

Some technologies have emerged to create on-demand customized screen protectors. For instance, a retailer can inventory basic supplies and materials. When a customer arrives at the facility, the dimensions of the customer's device can be determined. Those dimensions can then be used to custom-create in real-time a screen protector for the customer's device using the stock supplies and materials.

Although technologies exist for the on-demand creation of screen protectors to protect against scratches, there is a substantial need to improve the technologies related to repairing device screens after they have been scratched. That is, technologies are in place for scratch prevention, but there is still a technical need with regard to steps performed after an unfortunate instance in which a scratch occurs.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to kits, systems, devices (e.g., hardware storage devices, computer numerical control (CNC) machines/devices, etc.), and methods for dynamically polishing and repairing a mobile device's surface (e.g., the screen).

In some embodiments, a computer system includes a CNC machine equipped with a candle bit and a staging area. The candle bit includes an end-mounted applicator (e.g., a sponge, pad, brush, or some other tool), and the staging area includes a reservoir that includes a paste. The system includes one or more processors and one or more computer-readable hardware storage devices that store instructions that are executable by the processors to cause the computer system to perform various operations. For instance, the computer system causes the end-mounted applicator, which is mounted on the candle bit, to move to a position above the reservoir (e.g., via use of the CNC machine). The end-mounted applicator is dipped into the paste in the reservoir and then removed from the reservoir. The end-mounted applicator is moved to a home position relative to a device that is to be polished, where the device is disposed on the staging area. The system rotates the candle bit at a predetermined rate such that the end-mounted applicator also rotates. The system also causes the rotating end-mounted applicator to contact the surface of the device while moving in accordance with a predetermined pattern. Consequently, the end-mounted applicator polishes the surface of the device using the paste.

In some embodiments, a computer system includes a CNC machine equipped with a candle bit and a staging area. The candle bit includes an end-mounted applicator, and a paste is coated on the end-mounted applicator. In some embodiments, the candle bit and/or the CNC machine are equipped with one or more sensors. The one or more sensors may be configured to monitor the progression of a polishing and/or repair process. For example, the one or more sensors may be configured to monitor a temperature of the surface of the device during the polishing and/or repair process. Additionally, and/or alternatively, the one or more sensors may be configured to monitor a pressure of the candle bit (or an applicator mounted to the candle bit) during the polishing and/or repair process. Additionally, and/or alternatively, the one or more sensors may be configured to monitor a rotation rate of the candle bit (and/or an applicator mounted to the candle bit) during the polishing and/or repair process. In some embodiments, the rotation rate and the pressure of the candle bit are related. Additionally, and/or alternatively, the one or more sensors may be configured to monitor and/or detect edges and corners of the device.

Here, a device is disposed on a free-floating mount of a platform of the staging area. The system moves the candle bit (e.g., using the CNC machine) to a home position relative to the device, which is to be polished using the paste coated on the end-mounted applicator. The system also rotates the candle bit at a predetermined rate such that the end-mounted applicator is also rotated. The system causes the end-mounted applicator to contact a surface of the device, resulting in the paste contacting the surface. The system moves the rotating candle bit in accordance with a predetermined pattern to cause the end-mounted applicator, which is coated with the paste and in contact with the surface of the device, to polish the surface of the device.

In some embodiments, an applicator is coated with a paste using a CNC machine. Here, the applicator is attached to a candle bit of the CNC machine, and a device is disposed on a staging area of the CNC machine. The embodiments move the applicator and/or the staging area using the CNC machine such that the applicator is positioned above a selected area of the surface of the device. The embodiments also rotate the applicator at a predetermined rate using the CNC machine. The embodiments additionally move the applicator and/or the staging area using the CNC machine to cause the applicator to contact the surface. The embodiments also move the applicator and/or the staging area using the CNC machine in accordance with a predetermined pattern, which is selected to enable the paste and the applicator to polish the surface of the device, including a scratch on the surface.

In some embodiments, a kit includes a paste for polishing and/or repairing the surface of the device, including a scratch on the surface. The kit may additionally include one or more polishing pads to be used in the polish and/or repair process. In some embodiments, the polishing pads come pre-soaked with the paste. The kit may also include a pre-treatment solution for removing an oleophobic coating on the surface of the device prior to performing the polish and/or repair process. The kit may further include floating mounts for securing the device to a platform or a staging area of, for example, a CNC machine. The kit may include an oleophobic coating to be applied to the surface of the device after the polishing and/or repair process has been completed. The kit may also include a memory storage device containing executable instructions that configure a CNC machine to perform the polishing and/or repair processes described herein.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter. Features and/or properties of a given embodiment or implementation of the present disclosure can be combined with and/or incorporated into other embodiments or implementations of the present disclosure.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1A and 1B illustrate an example architecture for dynamically polishing and/or repairing a device's surface (e.g., the screen).

FIG. 2 illustrates an example user interface that can be used to configure the disclosed systems in order to polish and repair a surface.

FIG. 3 illustrates a flowchart of an example method for dynamically polishing and/or repairing a device's surface.

FIG. 4 illustrates an example of a CNC machine equipped with various features to facilitate the dynamic process of polishing and/or repairing a device's surface.

FIG. 5 illustrates an example of a staging area.

FIG. 6 illustrates an example of a platform and various floating mounts.

FIG. 7 illustrates how a device can be positioned on the floating mounts so that the device can be floating above the platform.

FIG. 8 illustrates another example of the staging area.

FIG. 9 illustrates an example of a splash guard disposed on the staging area.

FIGS. 10, 11, and 12 illustrate various views of a candle bit.

FIG. 13 illustrates how a sponge (i.e. a type of applicator) can be mounted on the candle bit.

FIGS. 14A and 14B illustrate a process flow by which a device's surface can be polished and repaired using the disclosed techniques. FIG. 14C illustrates another example path or pattern that may be implemented in the polish and/or repair process.

FIG. 15 illustrates a flowchart of an example method for dynamically polishing and repairing a surface.

FIG. 16 illustrates one example view of a CNC machine equipped with various features to enable the disclosed embodiments to polish and repair a device's surface.

FIG. 17 illustrates another example view of a CNC machine equipped with various features to enable the disclosed embodiments to polish and repair a device's surface.

FIG. 18 illustrates another example view of a CNC machine equipped with various features to enable the disclosed embodiments to polish and repair a device's surface.

FIGS. 19A-C illustrates a close-up view of the staging area.

FIG. 20 illustrates a close-up view of the CNC machine's motor.

FIG. 21 illustrates a close-up view of the reservoir and a splash guard.

FIG. 22 illustrates a flowchart of an example method for dynamically repairing and/or polishing a device's surface.

FIG. 23 illustrates an example computer system configured to perform any of the disclosed operations.

FIGS. 24A-B illustrate examples of an enclosure or covering for individual CNC machines.

FIG. 25 illustrates an example of a foam and polishing pad (i.e. an applicator) mounted on the candle bit.

FIGS. 26A-H illustrate various examples of a polishing pad.

FIGS. 27A-B illustrate an additional or alternative example of a platform.

FIG. 28 illustrates an example of thermal images captured during a polishing and/or repair process.

FIG. 29A is a front perspective view of one embodiment of an enclosure. FIGS. 29B-C are front and back views of one embodiment of the enclosure.

FIGS. 29D-E are top and bottom views of one embodiment of the enclosure.

FIGS. 29F-G are left and right views of one embodiment of the enclosure.

FIG. 30A is a front perspective view of one embodiment of a staging area. FIGS. 30B-C are front and back views of one embodiment of the staging area.

FIGS. 30D-E are top and bottom views of one embodiment of the staging area.

FIGS. 30F-G are left and right views of one embodiment of the staging area.

FIG. 31A is a front perspective view of one embodiment of a candle bit with an applicator. FIGS. 3B-C are left and right views of one embodiment of the candle bit with an applicator.

FIGS. 31D-E are top and bottom views of one embodiment of the candle bit with an applicator. FIGS. 31F-G are front and back view of one embodiment of the candle bit with an applicator.

FIG. 31H is a bottom perspective view of the applicator of the candle bit. FIG. 31I is a side perspective view of the candle bit with an applicator.

FIGS. 32A-B are left and right views of one embodiment of a polishing pad.

FIGS. 32C-D are top and bottom views of one embodiment of the polishing pad.

FIGS. 32E-F are front and back views of one embodiment of the polishing pad.

FIG. 33A is a front perspective view of one embodiment of a platform. FIGS. 33B-C are left and right views of one embodiment of the platform.

FIGS. 33D-E are top and bottom views of one embodiment of the platform.

FIGS. 33F-G are front and back view of one embodiment of the platform.

FIG. 34A illustrates a perspective view of a z-finder puck.

FIG. 34B illustrates a perspective view of the z-finder puck of FIG. 34A being used in a calibration process.

FIGS. 35A-B illustrate another example of a z-finder puck.

FIG. 36 illustrates example pressure tabs for use in a pressure calibration process.

FIG. 37 illustrates a flowchart of an example method for dynamically removing an oleophobic coating from a device.

FIG. 38 illustrates flowchart of an example method for dynamically applying an oleophobic coating to a device.

FIG. 39 illustrates examples of beading that may be detected on the surface of a device when an oleophobic coating is present and when the oleophobic coating has been removed.

### DETAILED DESCRIPTION

Embodiments disclosed herein relate to kits, systems, devices (e.g., hardware storage devices, computer numerical control (CNC) machines/devices, etc.), and methods for dynamically polishing and/or repairing a mobile device's surface (e.g., the screen).

In some embodiments, a computer system includes a CNC machine equipped with a candle bit and a staging area. The candle bit includes an end-mounted applicator, and the staging area includes a reservoir that includes a paste. The system includes one or more processors and one or more computer-readable hardware storage devices that store instructions that are executable by the one or more processors to cause the computer system to perform various operations. For instance, the computer system causes the end-mounted applicator, which is mounted on the candle bit, to move to a position above the reservoir. The end-mounted applicator is dipped into the paste and then removed from the reservoir. The end-mounted applicator is moved to a home position relative to a device that is to be polished, where the device is disposed on the staging area. The system rotates the candle bit at a predetermined rate such that the end-mounted applicator also rotates. The system also causes the rotating end-mounted applicator to contact the surface of the device while moving in accordance with a predetermined pattern. Consequently, the end-mounted applicator polishes the surface of the device using the paste.

In some embodiments, a computer system includes a CNC machine equipped with a candle bit and a staging area. The candle bit includes an end-mounted applicator, and a paste is coated on the end-mounted applicator. In some embodiments, the candle bit and/or the CNC machine are equipped with one or more sensors. The one or more sensors may be configured to monitor the progression of a polishing and/or repair process. For example, the one or more sensors may be configured to monitor a temperature of the surface of the device during the polishing and/or repair process. Additionally, and/or alternatively, the one or more sensors may be configured to monitor a pressure of the candle bit (or an applicator mounted to the candle bit) during the polishing and/or repair process. Additionally, and/or alternatively, the one or more sensors may be configured to monitor a rotation rate of the candle bit (and/or an applicator mounted to the candle bit) during the polishing and/or repair process. Additionally, and/or alternatively, the one or more sensors may be configured to monitor and/or detect edges and corners of the device.

Here, a device is disposed on a free-floating mount of a platform of the staging area. The system moves the candle bit to a home position relative to the device, which is to be polished using the paste coated on the end-mounted applicator. The system may move the candle bit toward a surface of the device such that the candle bit hovers a distance from the surface of the device, where the distance may be predetermined. The system also rotates the candle bit at a predetermined rate such that the end-mounted applicator is also rotated. The system causes the end-mounted applicator to contact a surface of the device, resulting in the paste contacting the surface. The system moves the rotating candle bit in accordance with a predetermined pattern to cause the end-mounted applicator, which is coated with the paste, to polish the surface of the device.

In some embodiments, an applicator is coated with a paste using a CNC machine. Here, the applicator is attached to a candle bit of the CNC machine, and a device is disposed on a staging area of the CNC machine. The embodiments move the applicator and/or the staging area using the CNC machine such that the applicator is positioned above a selected area of the surface of the device. The embodiments also rotate the applicator at a predetermined rate using the CNC machine. The embodiments additionally move the applicator and/or the staging area using the CNC machine to cause the applicator to contact the surface. The embodiments also move the applicator and/or the staging area using the CNC machine in accordance with a predetermined pattern, which is selected to enable the paste and the applicator to polish the surface of the device, including a scratch on the surface.

In some embodiments, a kit includes a paste for polishing and/or repairing the surface of the device, including a scratch on the surface. The kit may additionally include one or more polishing pads to be used in the polish and/or repair process. In some embodiments, the polishing pads come pre-soaked with the paste. The kit may also include a pre-treatment solution for removing an oleophobic coating on the surface of the device prior to performing the polish and/or repair process. The kit may further include floating mounts for securing the device to a platform or a staging area of, for example, a CNC machine. The kit may include an oleophobic coating to be applied to the surface of the device after the polishing and/or repair process has been completed. The kit may also include a memory storage device containing executable instructions that configure a CNC machine to perform the polishing and/or repair processes described herein.

It should be noted that while many of the examples presented herein focus on the use of a “sponge,” any type of “applicator” (e.g., a pad, brush, etc.) can also be used. Accordingly, reference to a “sponge” is for example purposes only and should not be viewed as limiting the disclosure. Furthermore, many examples herein use the term “screen.” One will appreciate how the principles can be applied to any type of “surface” for a device.

### Examples Of Technical Benefits, Improvements, And Practical Applications

The following section outlines some example improvements and practical applications provided by the disclosed embodiments. It will be appreciated, however, that these are just examples only and that the embodiments are not limited to only these improvements.

The disclosed embodiments bring about numerous and substantial benefits to the technical field. For instance, the disclosed embodiments are able to dynamically and in real-time polish and even repair a scratched screen or surface. User devices, such as phones, watches, tablets, or even laptops, are often subjected to abuse or hard use. As an example, consider a scenario where a user is at the beach and places his/her phone in a pocket. Sand is likely to enter the user's pocket and scratch the user's phone. A parent might have a child who uses an object to scratch the parent's phone. Indeed, all sorts of scenarios can occur where a device's screen can be scratched.

Further, the disclosed embodiments beneficially prevent wasting of the paste used to polish or repair the surface of the device. For example, lowering the candle bit to hover a distance above the surface and beginning rotation of the candle bit prior to contacting the surface minimizes spray off of the paste from the candle bit and/or an end-applicator attached to the candle bit. A speed of rotation or movement of the candle bit may be ramped up after the candle bit has contacted the surface. This also beneficially results in less torque being applied to a motor of the CNC machine, enabling a quieter process for an operator and a longer life of the motor. Increasing the speed of rotation or movement of the candle bit after contacting the surface of the device also provides a more consistent polishing pattern.

In accordance with the disclosed principles, the embodiments are able to repurpose, or rather multipurpose, a CNC machine to enable that CNC machine to polish and even repair certain levels of scratches. For instance, consider the Mohs Hardness Scale. The Mohs Hardness Scale is a qualitative scale that characterizes the scratch resistance of various substances, such as the glass used for device screens. The disclosed embodiments are beneficially able to repair scratches that generally fall within the range of 1 to 7 in the Mohs Hardness Scale. Using the CNC machine, the embodiments are able to apply a scratch-repairing “paste” to the screen and then buffer or polish that paste on the screen in order to repair the scratch. Further details on these operations will be provided later. In any event, however, the embodiments improve the technical field by facilitating the dynamic repair of scratched screens. Accordingly, these and numerous other benefits will now be discussed in detail throughout the remaining portions of this disclosure.

### Screen Repair Architecture

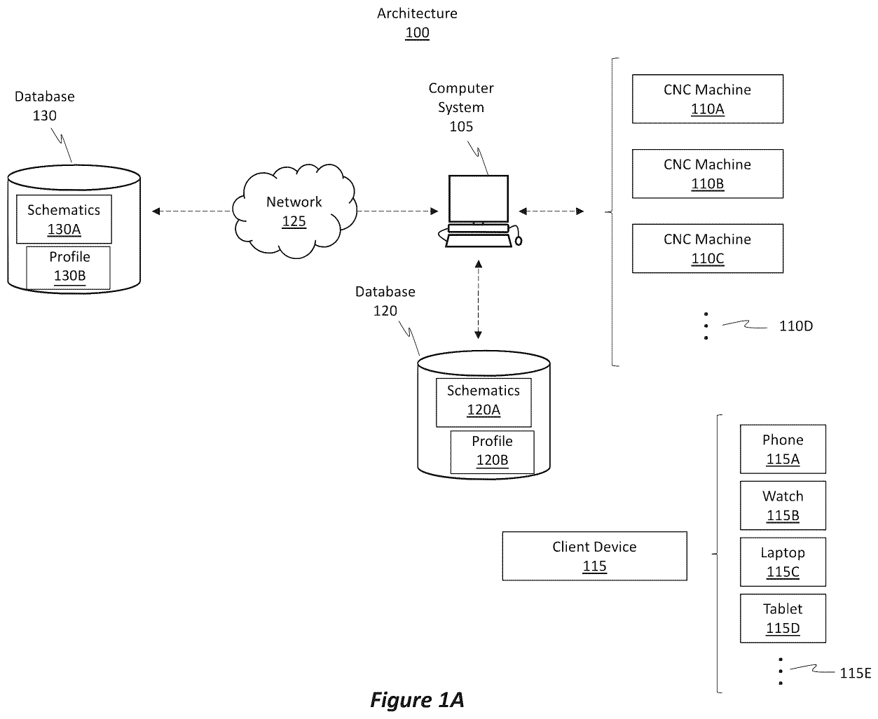

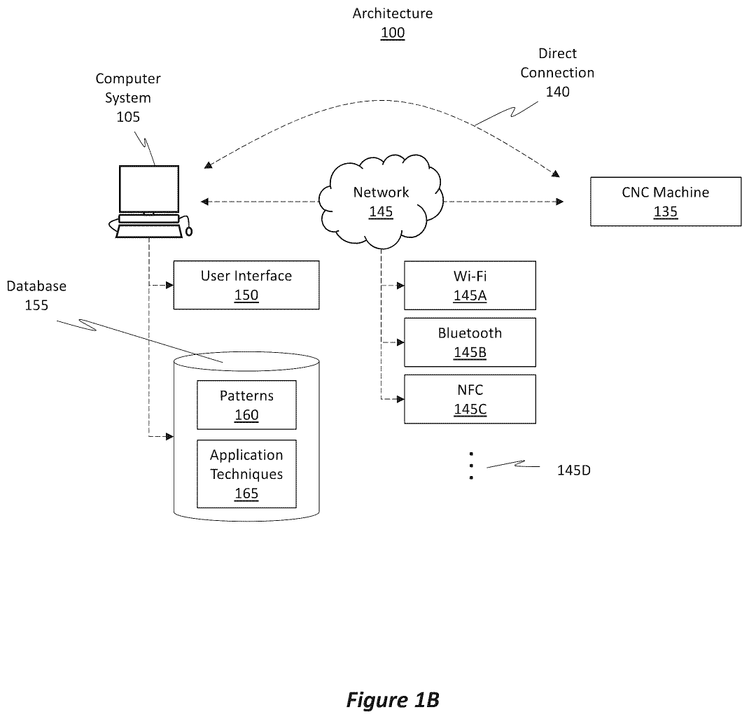

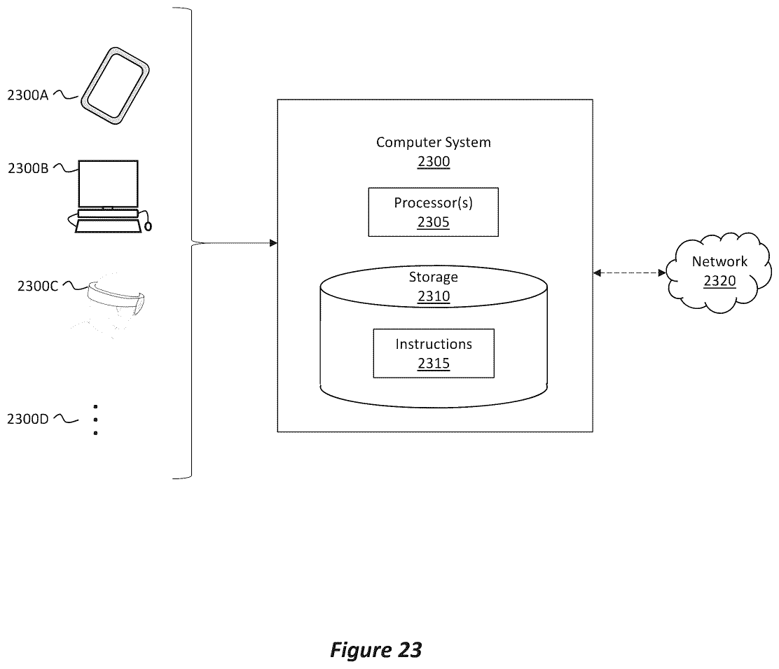

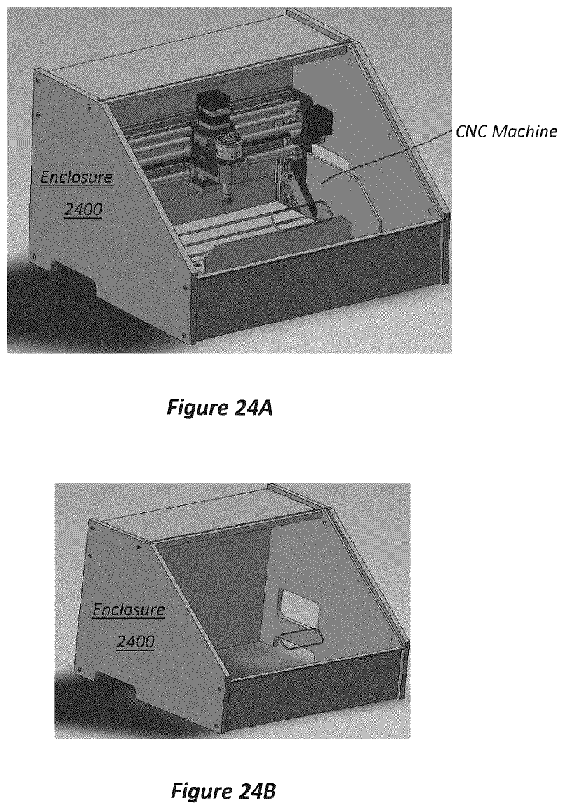

Attention will now be directed to FIGS. 1A and 1B, which illustrate an example architecture 100 that may be used to facilitate the dynamic polishing and repair of a screen. Architecture 100 is shown as including a computer system 105, which (as will be discussed in more detail with regard to FIG. 23) can be any type of computer system. The computer system 105 controls the operations of CNC machines, such as CNC machines 110A, 110B, and 110C. The ellipsis 110D demonstrates how the computer system 105 can control any number of CNC machines. In some cases, the CNC machines operate in parallel in order to repair and/or polish any number of devices at the same time or overlapping time period. In some cases, the CNC machines may include an enclosure or covering to be placed over individual CNC machines. (See FIG. 24). The enclosure or covering may cut down on sound during a polishing and repair process. Additionally, the enclosure or covering may keep a workspace clean of debris resulting from a polishing and repair process.

As an example, a client device 115 can be positioned on one of the CNC machines, such as perhaps CNC machine 110A. As shown in FIG. 1A, the client device 115 can be any type of device including, but not limited to, a phone 115A, a watch 115B, a laptop 115C, or even a tablet 115D. The ellipsis 115E demonstrates how any other type of device can be repaired or polished using the disclosed principles as well.

In some embodiments, the computer system 105 includes or has access to a local database 120 comprising various schematics 120A for any number or type of phones. The schematics 120A include the dimensions of the phone as well as other features of the phone, such as whether the phone includes a front and/or backward facing camera, speakers, buttons, microphones, rounded corners, rounded edges, and so on. Indeed, the schematics 120A can describe any physical feature of the client device 115. In some embodiments, the local database 120 further comprises at least one profile 120B. The at least one profile 120B may include client profiles and/or device profiles. For example, profile 120B may include information relating to the type of device (e.g., a phone, tablet, watch, etc.), a polishing and/or repair history of the device, a scratch history of the device, device schematics and/or dimensions, a gyroscope history, among other things. The polishing and/or repair history of the device may include information relating to the type of scratch polished and/or repaired, adjustments made during the polishing and/or repair process (e.g., one or more z-heights of the device, one or more RPM counts during the polishing and/or repair process, etc.), a number of polishing and/or repair processes the device has gone through and a pattern used in the polishing and/or repair process. This information may be stored and/or recorded to the local database 120 before, during, and after a polishing and/or repair process has been completed.

In some cases, the computer system 105 communicates over a network 125 with a remote database 130 that includes schematics 130A of the client device 115. In some implementations, the computer system 105 can download or cache the schematics 130A to the local database 120. In any event, the dimensions, or rather “schematics,” of the client device 115 are used in order to facilitate the polishing and repair process. In some cases, the network 125 can be a cloud network. Further details on this aspect will be provided momentarily. In some embodiments, the remote database 130 further comprises at least one profile 130B. The at least one profile 130B may include client profiles and/or device profiles. For example, profile 130B may include information relating to the type of device (e.g., a phone, tablet, watch, etc.), a polishing and/or repair history of the device, a scratch history of the device, device schematics and/or dimensions, a gyroscope history, among other things. The polishing and/or repair history of the device may include information relating to the type of scratch polished and/or repaired, adjustments made during the polishing and/or repair process (e.g., one or more z-heights of the device, one or more RPM counts during the polishing and/or repair process, etc.), a number of polishing and/or repair processes the device has gone through and a pattern used in the polishing and/or repair process. This information may be stored and/or recorded to the local database 120 before, during, and after a polishing and/or repair process has been completed.

The architecture 100 is further illustrated in FIG. 1B. For instance, the computer system 105 is shown as well as a CNC machine 135, which can be any of the CNC machines mentioned in FIG. 1A. In some cases, the computer system 105 has a direct connection 140 with the CNC machine 135, such as perhaps via a USB connection, ethernet connection, or some other direct connection. In some cases, the computer system 105 has a wireless or a networked connection with the CNC machine 135, as shown via network 145. The network 145 connection can be a Wi-Fi 145A connection, a Bluetooth 145B connection, or a near field communication NFC 145C connection. The ellipsis 145D illustrates how other types of connections can be used as well. For instance, the CNC machine 135 might be located remotely from the computer system 105. In such a scenario, the network 145 connection might include any type of Internet connection between the computer system 105 and the CNC machine 135. Accordingly, the computer system 105 is able to use wired or wireless communication techniques to communicate with the CNC machine 135.

It should be noted how the CNC machine 135 includes a so-called “candle bit,” and this candle bit is used to perform the polishing and repair process. The CNC machine 135 supports multiple types of “candle bits” which can be exchanged or swapped out according to the function being carried out. As will be described in more detail later, the candle bit is equipped with a sponge or sponge-like material or some other applicator (e.g., a pad, brush, or some other tool) that can be coated using a scratch-repairing paste or substance. The CNC machine then moves the candle bit, which includes the sponge, to a position over top of the device's screen. The candle bit is rotated and lowered onto the screen and then used to polish the screen. A “pass” refers to an operation in which the CNC machine navigates or moves the candle bit and sponge to various locations or areas across the screen in order to polish the screen. In some cases, a “pass” is delineated in time based on an instance when the sponge is newly coated with the paste (e.g., at time “A,” the sponge is coated then again at time “B” the sponge is coated; times “A” and “B” are used to delineate different passes).

For instance, a first pass might start when the sponge is coated with a paste and then used to polish a screen. A second pass might start when the sponge is coated, for a second time, with the paste and then used to polish the screen a second time. A third pass might start when the sponge is coated for a third time, and so on.

In some instances, a pass might refer to a scenario where the sponge is used to polish at least a selected portion of a screen for a first time without a substantial overlap between strokes or movements of the sponge over the screen (i.e. the same area of the screen is not repeatedly polished during the same pass). A second pass might start once the sponge is used to polish an area of the screen that has already been polished a first time, thereby resulting in an overlap polishing scenario, where the same area of the screen has been repeatedly polished at different points in time.

In some cases, a pass refers to a scenario where all or a substantial majority of the screen has been polished. A subsequent pass will then occur when the screen is subsequently polished a second time. In some cases, a pass might refer to a scenario where only a portion, but not an entirety, of the screen is polished. A subsequent pass will then occur when that portion of the screen is subsequently polished a second time.

In some cases, a first pass may polish edges of the device, a second and third pass may polish the surface of the device, and a fourth pass may again polish the edges of the device. In some cases, the first pass may polish the edges of the device in a clockwise direction and the fourth pass may polish the edges in a counterclockwise direction. In some cases, the second pass may polish the surface of the device in an x-direction and a y-direction (i.e., in orthogonal directions). In some cases, the third pass may polish the surface of the device in a z-direction (i.e., a vertical direction). As used herein, the surface of the device includes any outer portion of the device and is not limited to glass portions or touch-sensitive/touch-reactive portions of the device. The edges and corners of the device are included as part of the surface of the device.

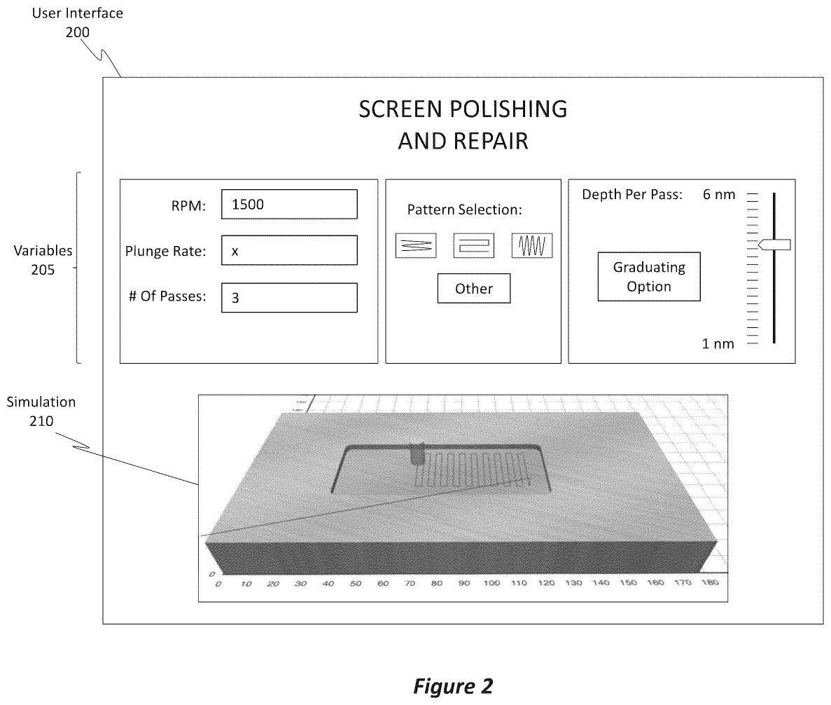

Returning to FIG. 1B, the computer system 105 is able to host or display a user interface 150 in order to enter data to control the polishing and repair process. The user interface 200 of FIG. 2 is illustrative.

Specifically, FIG. 2 shows an example user interface 200 designed to have a particular layout by which a user can easily and intuitively enter information in order to facilitate the polishing and repair process. To illustrate, the user interface 200 includes various user interface (UI) elements for entering variable information, as shown by variables 205. The variables 205 include a rotation rate for the candle bit used by the CNC machine, a plunge rate by which the candle bit is raised and lowered, and a number of passes that will be used to polish the device. The variables 205 also include options to select a pattern, which will be followed by the candle bit when polishing the device. Predefined patterns can be selected or, alternatively, a user can custom create a pattern.

The variables 205 also include options for specifying the depth of the candle bit when contacting the screen. By “depth,” it is meant how close the candle bit is to the screen and how much the sponge is compressed onto the screen. The sponge on the end of the candle bit can have any size, such as perhaps 1cm in height or depth. Sponges can easily compress when flattened. By increasing the “depth per pass” using the user interface 200, the embodiments cause the sponge to be pressed more or harder into the screen by causing the candle bit to be closer to the screen without the candle bit contacting the screen; instead, only the sponge (and paste material on the sponge) contact the screen. Increased pressure on the screen using the sponge results in a firmer contact between the sponge and the screen, resulting in perhaps a harder or more coarse polishing of the screen.

In some cases, a different depth of the candle bit (and hence the sponge) can be used for different passes. As an example, suppose during the first pass or run of the candle bit over the screen, the depth is set to 4 nanometers (nm). During the second pass, the depth might be set to 5 nm. During the third pass, the depth might be set to 6 nm. Based on this, one can appreciate how a graduating depth can be specified using the user interface 200 for different passes and/or even for the same pass. For instance, the depth might increase or decrease within one pass, such as perhaps in the case where a particular area of the screen requires increased polishing as compared to other areas of the screen.

In some cases, the “depth per pass” variable can refer to an amount of screen material that is etched off or removed from the screen during each pass. The paste facilitates removal or etching off of the amount of screen material. For instance, during a first pass, perhaps 3 nm of screen material are removed from the screen. During a second pass, perhaps 2 nm of screen material are removed. During a third pass, perhaps 1 nm of screen material is removed. Accordingly, in different scenarios, the “depth per pass” variable can refer to different outcomes, where one outcome refers to the firmness by which a sponge is pressed against a screen while a different outcome refers to the amount of screen material that is removed during each pass.

The user interface 200 also includes a simulation 210 depicting how the resulting polishing operations will appear in a simulated manner. This simulation 210 is useful because it enables a user to see how the polishing and repair process will look like based on the entered variables 205. In some cases, the simulation 210 may include information such as a temperature of a surface of the device during the polishing and repair process.

In some cases, the data for the variables 205 is entered automatically based on the schematics of whichever device is being polished or repaired. For instance, not only can the databases mentioned earlier include schematic information, but those databases can also include information used to populate the entries in the user interface 200 for the variables 205. In some cases, the data for the variables 205 is entered automatically based on accessing a profile 120B, 130B from the local or remote database 120, 130. The variables 205 may be automatically entered based on the type of device, the polishing and/or repair history of the device, the scratch history of the device, the gyroscope history of the device, among other things. The variables 205 entered may be stored to the profiles 120B, 130B after completion of a polishing and/or repair process.

In some cases, machine learning can be used in order to populate the entries for the variables 205. For instance, an image of the device can be captured using a camera. Here, the device might include any number of scratches on its screen. The image can be fed as input into the machine learning algorithm, which can then analyze the image to determine the severity of the scratches. Based on the determined severity, the machine learning (ML) algorithm can generate a set of values for the variables 205, where those values are designed in order to provide perhaps a best likelihood for repairing the screen.

Any type of ML algorithm, model, machine learning, or neural network may be used. As used herein, reference to “machine learning” or to a ML model or to a “neural network” may include any type of machine learning algorithm or device, neural network (e.g., convolutional neural network(s), multilayer neural network(s), recursive neural network(s), deep neural network(s), dynamic neural network(s), etc.), decision tree model(s) (e.g., decision trees, random forests, and gradient boosted trees), linear regression model(s) or logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations. Accordingly, the user interface 200 can be used to program the operations for the polishing and repair process.

Returning to FIG. 1B, the computer system 105 can interact with a database 155, which may be the database 120 from FIG. 1A or the database 130. The database 155 includes details on available patterns 160 that can be used by the CNC machine when polishing the device and/or details on available application techniques 165 for polishing or repairing the device. Further details on these features will be provided later.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

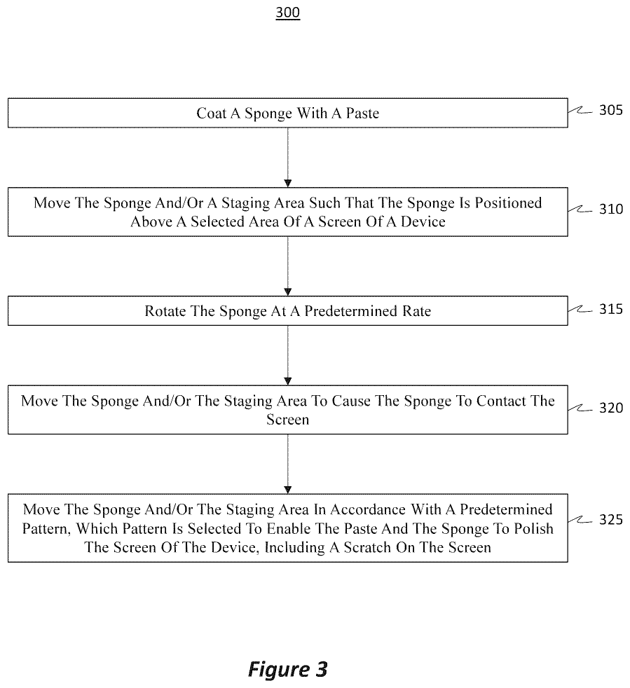

Attention will now be directed to FIG. 3, which shows a flowchart of an example method 300 for polishing and/or repairing a screen of a device. Method 300 can be implemented within the architecture 100 of FIGS. 1A and 1B. For instance, method 300 can be performed using the computer system 105 and the CNC machine 135.

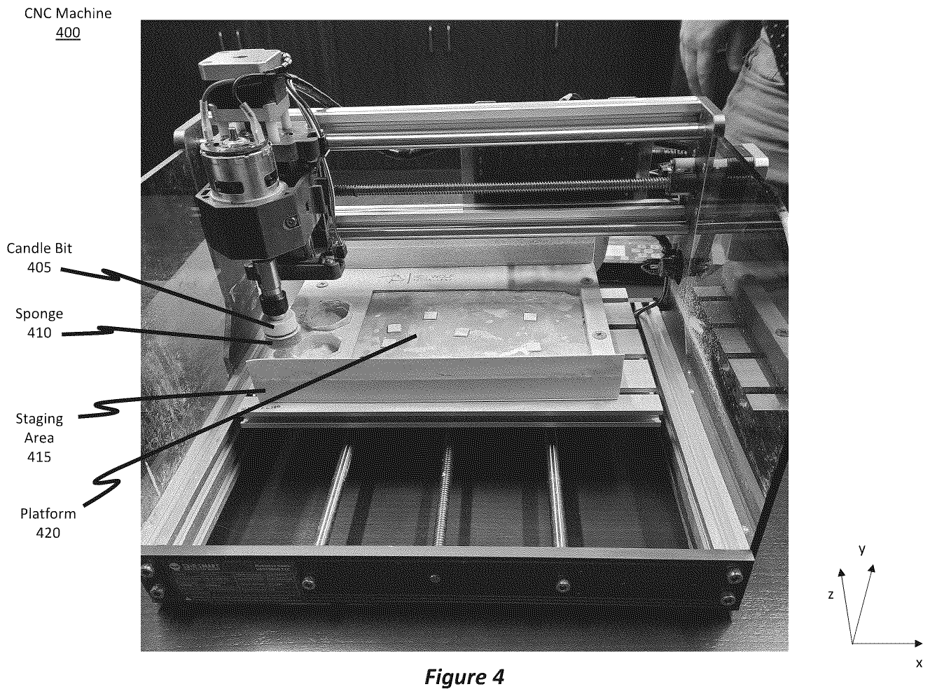

Initially, method 300 includes an act (act 305) of coating an applicator with a paste using a computer numerical control (CNC) machine. Notably, the applicator is attached to a candle bit of the CNC machine. Furthermore, the device is disposed on a staging area of the CNC machine. The applicator can be a sponge, pad, brush, or any other type of application tool. FIG. 4 is illustrative.

FIG. 4 shows an example CNC machine 400, which can be the CNC machine mentioned in method 300. The CNC machine 400 includes a candle bit 405. Attached to an end of the candle bit 405 is a sponge 410. This sponge 410 can be coated with a scratch-repairing or removing paste. The CNC machine 400 causes the candle bit 405 (and hence the sponge 410) to rotate at a selected rate. Typically, the selected rate is between about 500 RPM and 2,500 RPM, with a preferred range being between 1,000 RPM and 2,000 RPM. The RPM can also vary depending on various other factors, such as cycle stage, depth per pass, and scratch level.

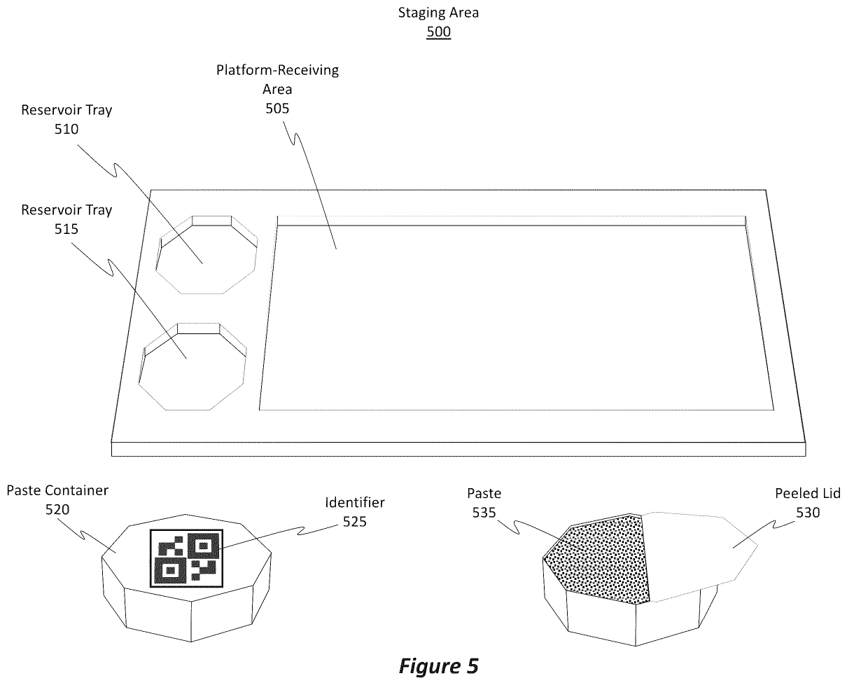

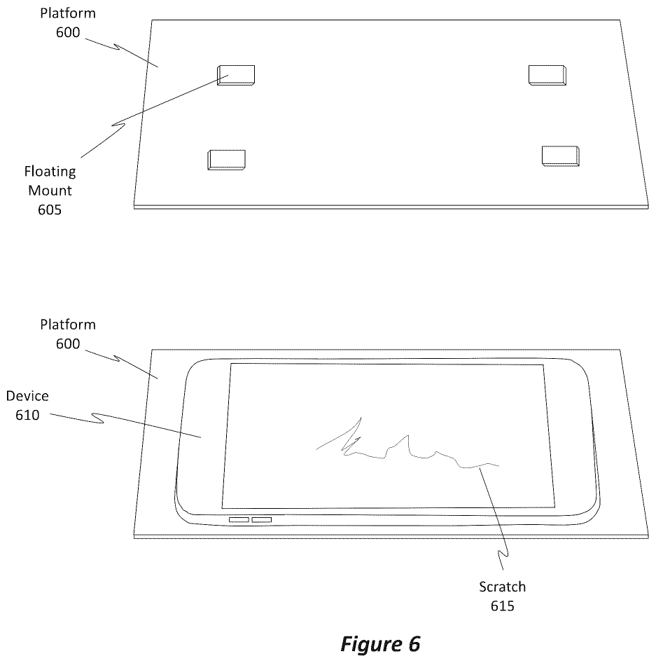

FIG. 4 also shows a staging area 415, which includes a platform 420 on which a device can be positioned. The device may be positioned on the platform 420 using floating mounts 605 (see FIG. 6). In some embodiments, floating mounts 605 can be or comprise a riser. In some embodiments, floating mounts 605 can be or be comprised of a non-slip or anti-slip material. In some embodiments, floating mounts 605 can be or comprise (strips or pieces of) rubber, (soft) latex, tape, gel, adhesive, grip tape, silicone, foam, or any other appropriate mounting or attachment mechanism. In some embodiments, In some cases, the staging area 415 is removably attached to the CNC machine via snaps, clips, bolts or any other appropriate fastener. In some cases, the staging area 415 is slidably attached to the CNC machine. Beneficially, the staging area 415 may be slid out of the CNC machine, for example, for cleaning. The staging area 415 may be slid back and locked into place in the CNC machine after cleaning. When the device is positioned on the platform 420 of the staging area 415, the CNC machine 400 can move the sponge 410 in an x-y dimensional plane. The CNC machine 400 can move the staging area 415 in a z dimension to raise or lower the device. Of course, these are example scenarios only. In some cases, the CNC machine 400 can move the sponge 410 in any x-y-z direction. In some cases, the CNC machine 400 can move the staging area 415 in any x-y-z direction. FIGS. 5 through 14B provide additional details regarding the staging area, the platform, the candle bit, and the sponge.

FIG. 5 shows an example of the staging area 500, which is representative of the staging area 415 of FIG. 4. The staging area 500 operates as an access area where the paste mentioned earlier can be stored as well as an area where the device can be placed in order to be accessible to the CNC machine.

To illustrate, the staging area 500 can include a platform-receiving area 505, which is a recessed portion of the staging area 500 where the platform 420 of FIG. 4 can be disposed within. One will appreciate how the size of the staging area 500 and the platform-receiving area 505 can be set to any size in order to accommodate any sized device. Further, the staging area 500 may include more than one platform-receiving area 505 to accommodate more than one platform 420 and more than one device. For example, the staging area 500 may include three platform-receiving areas 505 to polish and/or repair three devices at once. One will appreciate how the staging area 500 can include any number of platform-receiving areas 505 to accommodate any number of devices.

The staging area 500 also includes a recessed area labeled as a reservoir tray 510 and optionally another recessed area labeled as reservoir tray 515. Although two reservoir trays are illustrated, the embodiments can include 1, 2, 3, 4, 5, or more than 5 reservoir trays. Furthermore, although the reservoir trays are in the shape of an octagon, any shape (e.g., circle, triangle, square, rectangle, and so on) can be used.

A paste container 520 is structured to be insertable or placed within the reservoir tray 510 or 515. The paste container 520 can include an identifier 525, such as a QR code, a bar code, a serial number, or any other identifier. FIG. 5 shows a scenario where the lid of the paste container has been partially peeled off, as shown by peeled lid 530 to reveal the paste 535.

The paste 535 can be in liquid or powder form. The paste 535 is a scratch-removing paste that is designed to repair scratches in a screen. The paste may also enable or facilitate etching off or removal of an amount of screen material in a polish or repair process. In some cases, the paste container 520 is inserted into one of the reservoir trays 510, 515 while water or some other liquid substance is inserted into the other one of the reservoir trays 510, 515. The water can potentially be used to hydrate and liquify the paste 535 if in powder form. Additionally, or alternatively, the water can be used to cleanse or clean the sponge after the paste 535 was applied to a screen.

The paste container 520 can be inventoried and can be sold in bulk or individually. Often, the amount of paste 535 in the paste container 520 is sufficient for a one-time use, meaning there is enough paste 535 to fully polish and repair a single device. A new container will be inserted into the reservoir trays 510, 515 after that one-time use.

In some embodiments, the CNC machine is equipped with a larger container of paste, such as perhaps a tub that uses tubing to fill the reservoir trays 510, 515. The tub can be refilled when low.

In some cases, each sponge or applicator is a one-time-use sponge or applicator. Illustratively, each one-time-use sponge or applicator can be pre-configured, pre-loaded, or pre-dipped with paste. In some embodiments, to activate the paste, the sponge can be dipped in water. In other embodiments, the paste is pre-activated/hydrated.

FIG. 6 shows an example platform 600, which is representative of the platform 420 of FIG. 4. The platform 600 is insertable into the recessed platform-receiving area 505 shown in FIG. 5.

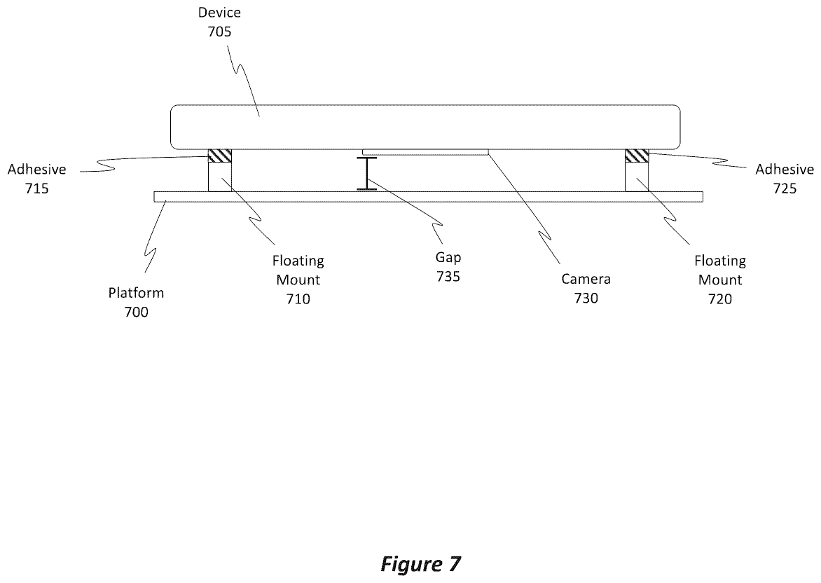

The platform 600 is structured to include any number of floating mounts, such as floating mount 605. The floating mount 605 operates as both a cushion on which a device can rest when being polished/repaired as well as a raised platform for suspending, or rather elevating, the device. FIG. 6 shows a device 610, which includes a scratch 615, positioned on the floating mounts 605 of the platform 600. Using the floating mounts 605, the device can be elevated in a floating manner. As used herein, the term “floating” or “floating manner” refers to a scenario where the device is elevated using a select number of supporting members (e.g., the floating mounts 605), such that a majority of the surface area of the device is not in contact with a ground plane or support plane; rather, only a small amount of surface area (e.g., perhaps less than ⅕ or 1/10 or 1/20 of the surface area of the device) is in contact with a support member (e.g., the floating mounts). FIG. 7 provides additional details.

FIG. 7 shows the platform 700, which is representative of the platforms mentioned thus far, as well as the device 705. Here the device is resting on a floating mount 710, which can include an adhesive 715 in order to secure the device 705 in place. Another floating mount 720 and adhesive 725 is used to further secure and elevate the device. Additionally, and/or alternatively, the floating mounts 710, 720 can be or comprise risers. In some embodiments, floating mounts 710, 720 can be or be comprised of a non-slip or anti-slip or non-skid material. In some embodiments, floating mounts 710, 720 can be or comprise (strips or pieces of) rubber, (soft) latex, tape, gel, adhesive, grip tape, silicone, foam, or any other appropriate mounting or attachment mechanism, preferably a non-adhesive, non-slip and/or non-skid material. In some embodiments, use of a non-adhesive, non-slip and/or non-skid materials can beneficially keeps the device in place, stable, and level, while avoiding sticking residues that may be left with the use of adhesives.

Many devices are now equipped with a camera(s) or other sensor on the back-end of the device. For instance, device 705 is shown as including a camera 730. Having the camera 730 on the back-end often results in the device 705 not being able to be level when placed on its back-end. Such a condition would prohibit the device 705 from being accurately polished/detailed. Therefore, the disclosed embodiments incorporate the use of the floating mounts 710, 720 in order to raise/elevate the device 705 so that the camera 730 will not impede the device's ability to lay flat. Notice, as a result of using the floating mounts 710, 720, there is now a gap 735 between the platform 700 and the camera 730, thereby resulting in the device 705 “floating” above or being elevated above the platform 700. The gap 735 is designed to be sufficiently large to ensure that the camera or other back-facing sensor is elevated above the platform 700.

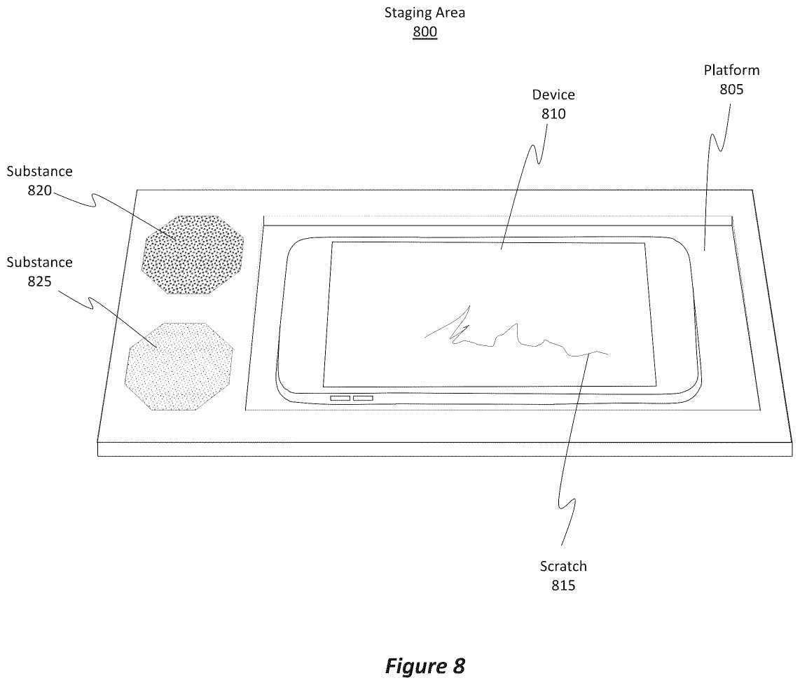

FIG. 8 shows the staging area 800 with the platform 805 inserted into the platform-receiving area. Here, a device 810 is secured in place using the platform 805, and the device 810 is shown as having a scratch 815. The staging area 800 is also shown as including a substance 820 and 825. Those substances can be water or the paste mentioned earlier or perhaps some other scratch-repairing substance. The platform 805 keeps the device level and secured. In some embodiments, floating mounts (such as those illustrated in FIG. 7) may also be used to help keep the device level and secured in place during a polishing and/or repair process.

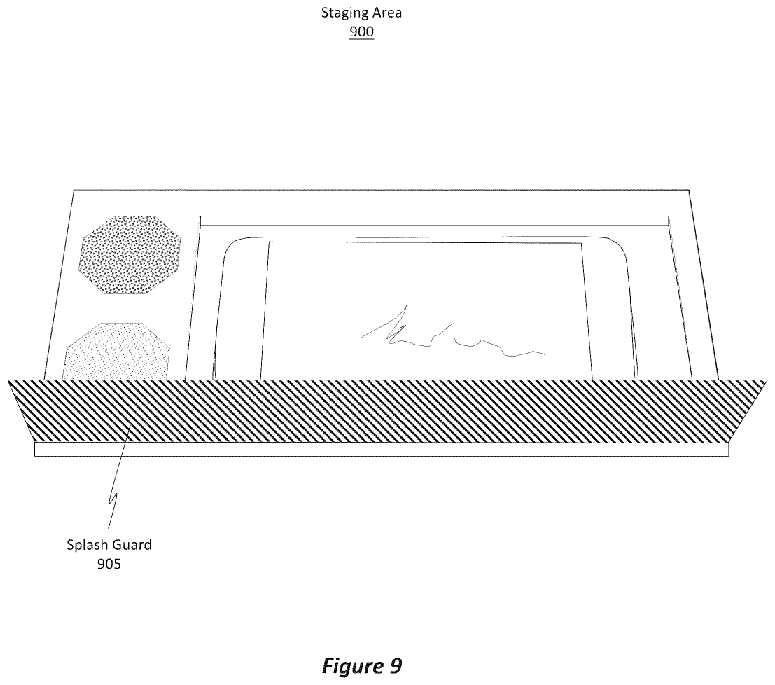

Some embodiments include a splash guard on the staging area, as shown by FIG. 9. Specifically, in some embodiments, the staging area 900 includes a splash guard 905 that is used to prevent the paste from splashing beyond the region confined by the splash guard 905. The dimensions of the splash guard 905 (e.g., height, width, and length) can be set to any suitable dimension to reduce or eliminate splatter. Further details on the splash guard will be provided later.

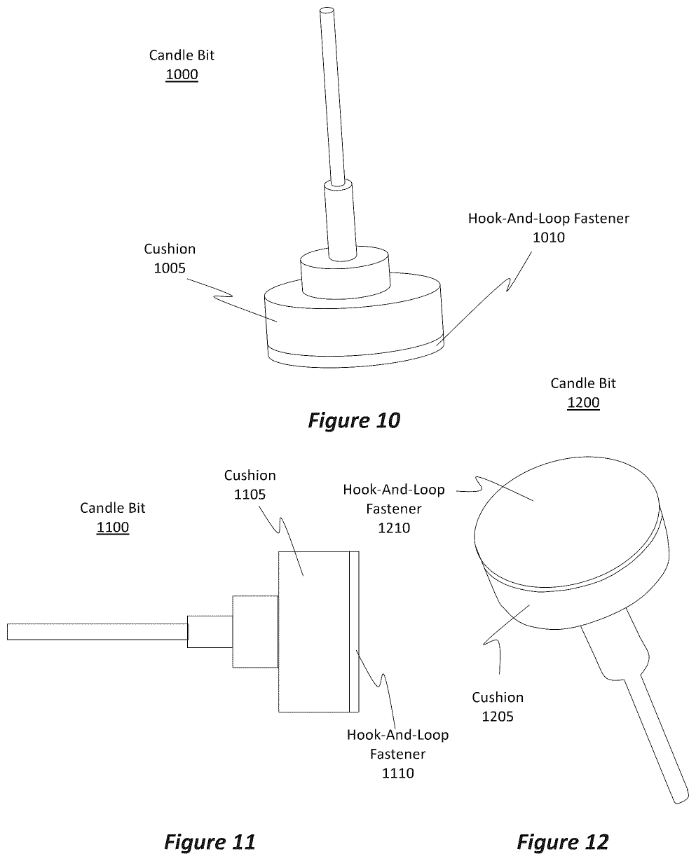

FIGS. 10, 11, and 12 illustrate various perspective views of the candle bit mentioned earlier. FIG. 10 shows a first perspective view of a candle bit 1000, which is representative of the candle bit 405 from FIG. 4 and which is connected to the CNC machine. The candle bit 1000 is rotated by a motor of the CNC machine and is moved to different positions in order to polish the device's screen. The candle bit 1000 includes a cushion 1005 section and a hook-and-loop fastener 1010. The hook-and-loop fastener 1010 is provided to enable a sponge to be attached to the end portion of the cushion 1005. The cushion 1005 can be made of any dampening material, such as rubber, plastic, sponge, and so on. The candle bit 1000 will be rotated by the CNC machine, as described previously.

FIG. 11 shows another perspective view of a candle bit 1100, which includes a cushion 1105 and a hook-and-loop fastener 1110. FIG. 12 shows yet another perspective view of a candle bit 1200, which includes a cushion 1205 and a hook-and-loop fastener 1210.

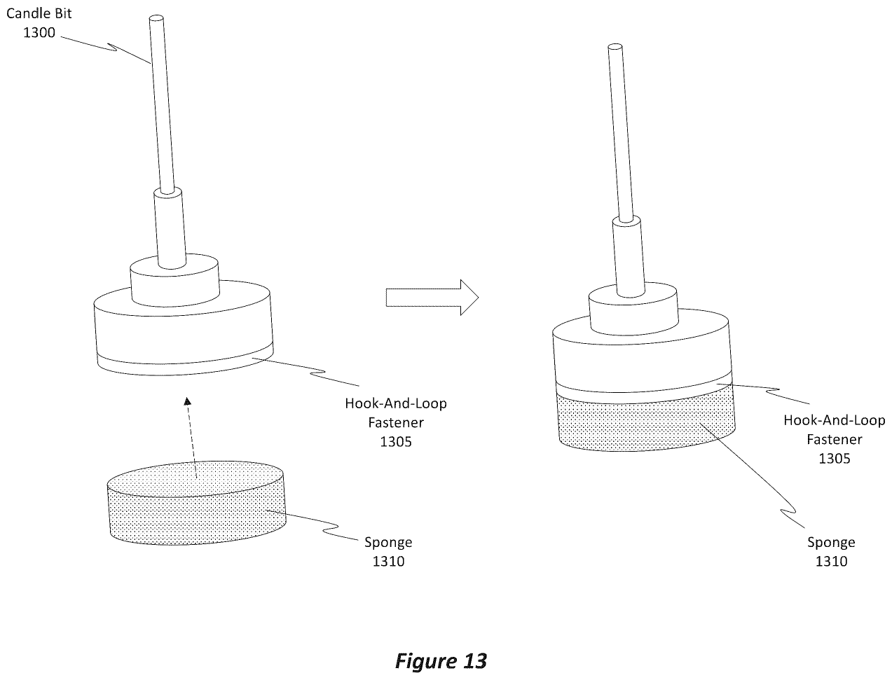

FIG. 13 shows a candle bit 1300, which includes a hook-and-loop fastener 1305, as well as a sponge 1310 (any other type of applicator can be used as well, such as a pad or brush), as mentioned previously. Here, the sponge 1310 can be connected or fastened to the candle bit 1300 via the hook-and-loop fastener 1305, as shown by the righthand illustration in FIG. 13.

Returning to FIG. 3, method 300 includes an act (act 310) of moving the applicator (e.g., sponge) and/or the staging area using the CNC machine such that the applicator is positioned above a selected area of the screen of the device. For instance, with reference to FIG. 4, the candle bit 405 and the sponge 410 combination can be moved by the CNC machine to a position above the platform 420, which is where the device will be positioned.

Act 315 includes rotating the applicator at a predetermined rate using the CNC machine. The motor of the CNC machine can rotate the candle bit and the applicator in combination. As discussed previously, the user interface 200 of FIG. 2 can be used to specify the RPM or rotation rate of the candle bit/applicator.

Act 320 includes moving the applicator and/or the staging area using the CNC machine to cause the applicator to contact the screen of the device. Act 325 then includes moving the applicator and/or the staging area using the CNC machine in accordance with a predetermined pattern, which pattern is selected to enable the paste coated on the applicator to polish the screen of the device, including a scratch on the screen.

Some embodiments provide reporting detailing how the surface repair operation occurred. For instance, some embodiments include a reporting and validation system. Here, the reporting can be used to present or describe conditions associated with the devices that were polished, processing time, temperatures, productivity, error reporting, and even locational statistics. The validation can be performed in an effort to ensure that only approved polish paste/media is used in (potentially) single-use cups or containers or larger applicator bottles.

In some embodiments, the reporting can be saved and/or recorded to a local and/or remote database (such as the local and/or remote databases illustrated in FIGS. 1A and 1B). The reporting may be saved to one or more profiles, such as a device and/or client profile. The reporting may include the conditions associated with the devices that were polished, adjustments made during the polishing and/or repair process, input variables associated with the polishing and/or repair process, polishing time, and a number of passes, among other things.

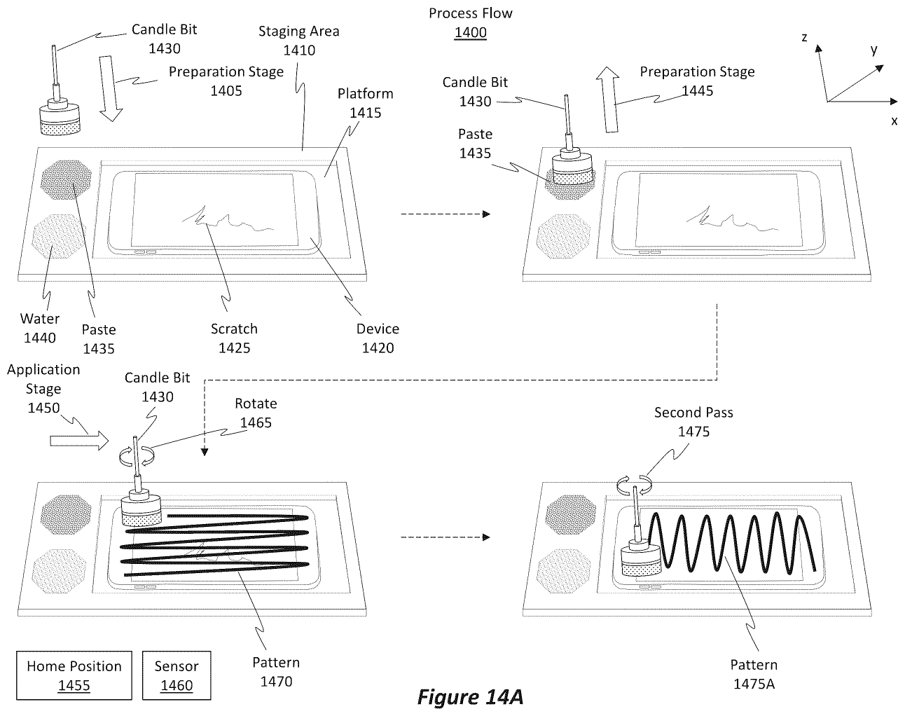

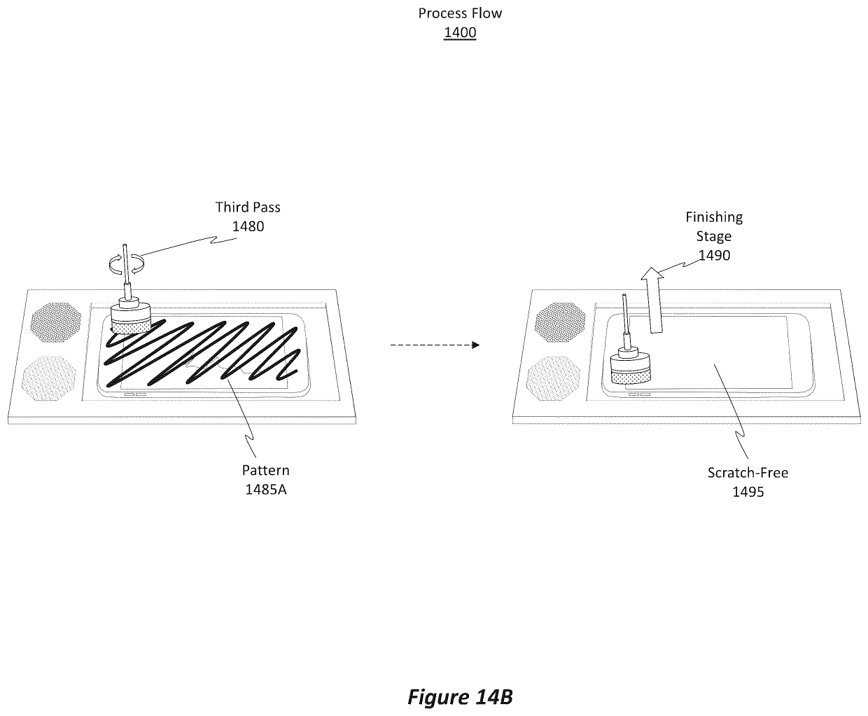

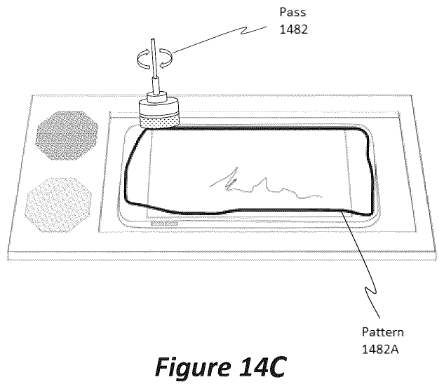

In some implementations, the process of coating the applicator with the paste is performed by using the CNC machine to dip the sponge or applicator into a container comprising the paste. As a consequence, the sponge is then coated with the paste. Optionally, the CNC machine can move the sponge in the x-y plane and can move the staging area in the z-dimension. In another embodiment, the process of polishing the screen of the device using the paste and the sponge can be performed by removing a selected or threshold amount of material from the screen using the paste. FIGS. 14A and 14B more fully describes acts 310 through 325. In various embodiments, the CNC machine can move (i) the staging area and/or (ii) the sponge or applicator in the x-y plane and can move (i) the staging area and/or (ii) the sponge or applicator in the z-dimension. In at least one embodiment, the CNC machine moves the sponge or applicator in the x-y plane and moves the sponge or applicator in the z-dimension.

FIGS. 14A and 14B show a process flow 1400 that includes an initial preparation stage 1405. Here, the preparation stage 1405 involves the use of the staging area 1410, the platform 1415, the device 1420 (which includes a scratch 1425), and a candle bit 1430. The staging area 1410 includes a paste 1435 and water 1440.

In this scenario, the CNC machine moves the candle bit 1430 to a location above the paste 1435. The CNC machine then causes the candle bit 1430 to be dipped into the paste 1430. This dipping action can occur by lowering the candle bit 1430 into the paste 1435 and/or by raising the staging area 1410 upwards to contact the paste 1435 with the candle bit 1430. In some cases, the candle bit 1430 is rotated at a slow rate, such as between 1 RPM to 60 RPM, while immersed in the paste 1435 in order to fully or substantially coat the surface area of the sponge with the paste 1430.

In the preparation stage 1445, the candle bit 1430 is separated from the paste 1435, such as by raising the candle bit 1430 and/or by lowering the staging area 1410. The x-y-z axis illustrates the various movement directions, with the z-axis reflecting a vertical movement while the x and y axes reflect orthogonal movements.

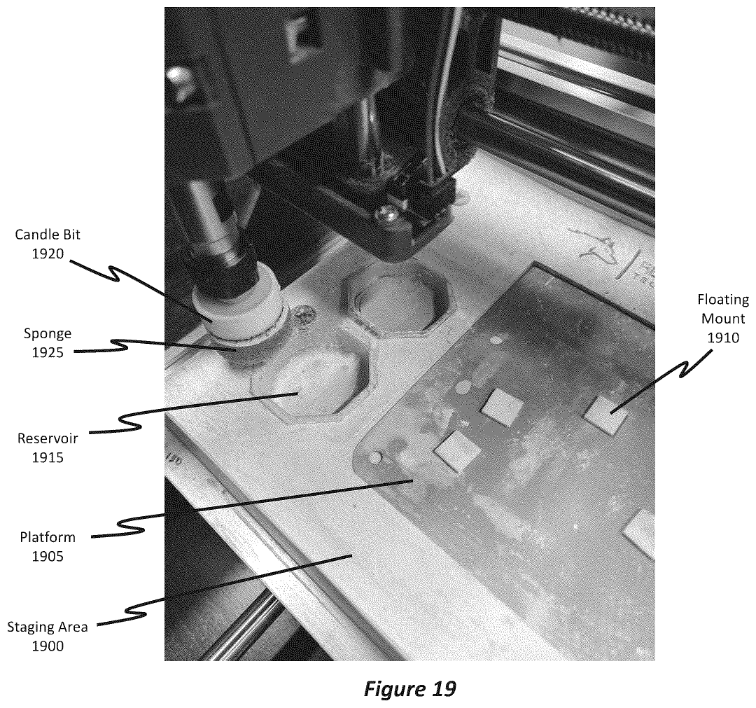

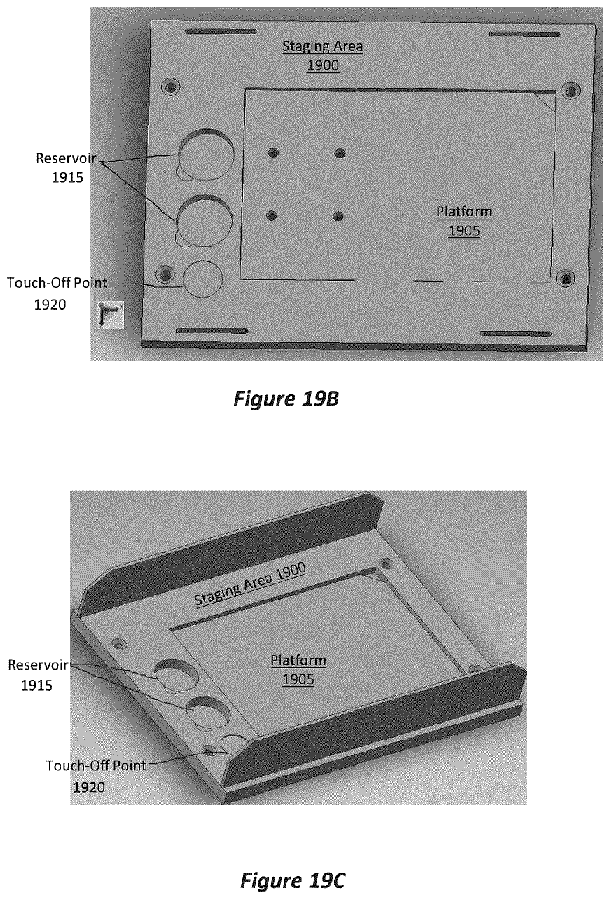

In some cases, the embodiments can auto-calibrate the z-axis to potentially facilitate the automatic calculation and determination of the home position 1455. For example, the staging area 1410 may additionally include a touch-off groove (see touch-off point 1920 illustrated in FIGS. 19B-C). The CNC machine moves the candle bit 1430 to a location above the touch-off point. The CNC machine then causes the candle bit 1430 to contact the touch-off point/groove. This contacting action can occur by lowering the candle bit 1430 onto the touch-off point/groove. Lowering the candle bit 1430 onto the touch-off point/groove 1480 calibrates a z-height of the staging area 1410 and the platform 1415.

In some cases, the embodiments can additionally auto-calibrate a z-height of the device 1420. This may also be referred to as finding or calibrating the “z zero” for a device. Some devices may have multiple, varied z zeroes, necessitating calibration in multiple locations of surface of the device. The CNC machine moves the candle bit 1430 to a location above the device 1420. The CNC machine then causes the candle bit 1430 to contact the surface of the device 1420 at a home position 1455 or another position on the device 1420. This contacting action can occur by lowering the candle bit 1430 onto the surface of the device 1420. Lowering the candle bit 1430 onto the surface of the device 1420 calibrates a z-height of the device 1420.

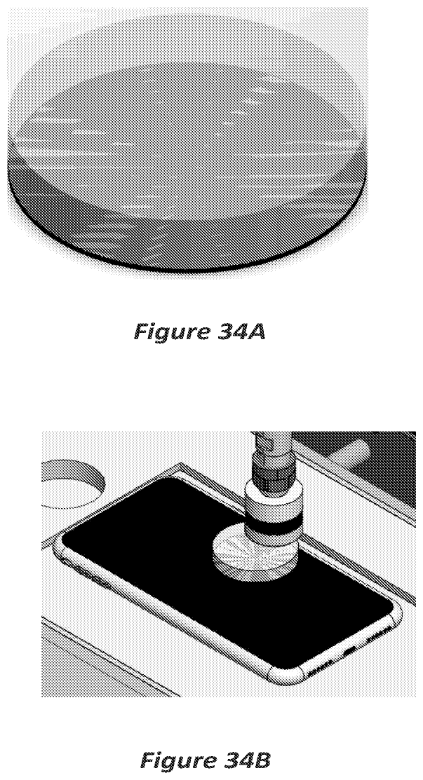

In some cases, the embodiments auto-calibrate a z-height of the device 1420 using a z-finder puck (sometimes referred to herein as the “z-finder puck,” “z-finder,” or simply “puck”). FIG. 34A illustrates an example of the z-finder puck and FIG. 34B illustrates an example of the z-finder puck being used to calibrate a z-height of the device 1420.

As illustrated in FIG. 34A, the z-finder puck includes a slick surface and an opposing, non-scratching surface. The slick surface is illustrated as transparent and glossy (indicated by the striations through the transparent portion of the puck). The slick surface may include acrylics, plastics, thermoplastics, another appropriate material and/or combinations thereof. The non-scratching surface may include felt, fabric, silk, another appropriate material and/or combinations thereof. The non-scratching surface of the puck may be configured to contact the device 1420 and slide around on a surface of the device 1420. The slick surface may be configured to engage the candle bit 1430 and/or a polishing pad attached to the candle bit. The dimensions of the puck (length×width×height) may be known. For example, a height of the puck may be approximately 6-8 mm thick, such as 6 mm, 6.5 mm, 7 mm, 7.5 mm or a range defined by any two of the foregoing values. The height of the puck may be 6.77 mm in some embodiments.

In some embodiments, such as that illustrated in FIG. 34B, to calibrate the z-height of the device 1420, the z-finder puck may be placed of the surface of the device 1420, such as at or around home position 1455. The CNC machine moves the candle bit 1430 to a location above the z-finder puck (which has been placed on the surface of the device 1420). In some embodiments, the candle bit 1430 is moved to a location approximately 7 mm above from the device 1420. For example, the candle bit 1430 may be approximately 6.8 mm, 6.9 mm, 7.1 mm, 7.2 mm. 7.3 mm above the device 1420, or a range defined by any two of the foregoing values. The CNC machine may lower the candle bit 1430 towards the z-finder puck (and, thus, towards the surface of the device 1420).

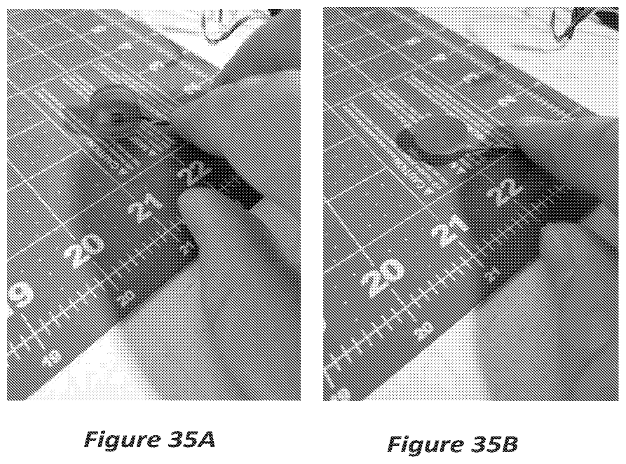

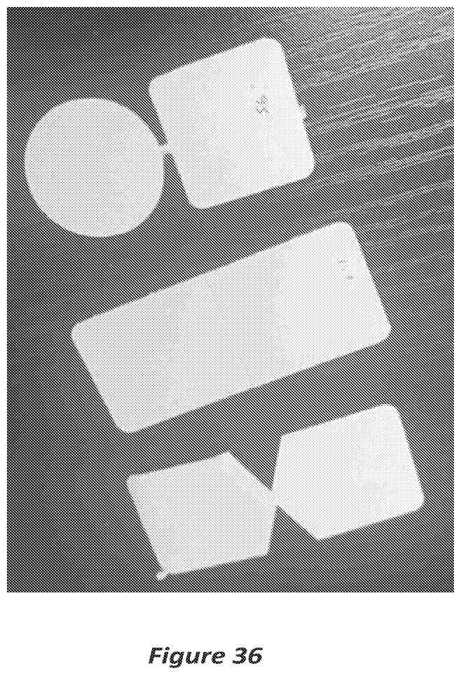

FIGS. 35A-B illustrate another example of a z-finder puck. The z-finder puck illustrated is an electronic z-finder puck. The dimensions of the puck (length x width x height) may be known. For example, a height of the puck may be approximately 6-8 mm thick, such as 6 mm, 6.5 mm, 7 mm, 7.5 mm or a range defined by any two of the foregoing values. The height of the puck may be 6.77 mm in some embodiments. The electronic z-finder puck is in electrical communication with the CNC machine. The electronic z-finder puck illustrated in FIGS. 35A-B plugs into the CNC machine, via a cord or wire (wires are illustrated in FIGS. 36A-B). Additionally, and/or alternatively, the electronic z-finder puck may have a battery (internal or external) to supply power to the electronic z-finder puck. For example, the electronic z-finder puck may have a watch-type battery incorporated into a body or housing of the puck. Similar to the z-finder pucks described herein, the electronic puck rests on the screen or surface of the device 1420. The CNC machine moves the candle bit 1430 to a location above the z-finder puck (which has been placed on the surface of the device 1420). In some embodiments, the candle bit 1430 is moved to a location approximately 7mm above the device 1420. For example, the candle bit 1430 may be approximately 6.8 mm, 6.9 mm, 7.1 mm, 7.2 mm. 7.3 mm above the device 1420, or a range defined by any two of the foregoing values.

The CNC machine may lower the candle bit 1430 towards the electronic z-finder puck (and, thus, towards the surface of the device 1420). Upon contacting the electronic puck, the CNC machine receives a signal and knows where the surface of the device 1420 is. The signal received by the CNC machine enables the CNC machines to know exactly where the surface or screen of the device 1420 is in reference to where the CNC machine received the signal from. The electronic z-finder puck may be placed in multiple locations on the surface of the device 1420 to enable calibration of a z-height in multiple locations of the device 1420.

As a non-limiting example, a tablet (e.g., an iPadTM) may have multiple and varying z-heights or z zeroes across the device. The edges, the corners and the surface of the device (e.g., the facial/planar surfaces of the tablet) may each have a different z-height. These z-heights may be knowable based on the schematics and/or dimension of the device, which may be stored to or accessible from a remote and/or local database. A z-finder puck may be placed in multiple, different locations on the surface of the device, such as 2, 4, 5, 6, 7, 8, 9 or 10 different locations.

For example, a z-finder puck may used to find a z-height at each corner, at various places along each edge (e.g., moving from the middle of each edge toward each corner) and at various places around the surface of the tablet. The z-height in substantially the middle of surface of the tablet may be greater than the z-height at the edges and/or corners. Determining the multiple, different z-heights will influence the pressure to be applied by the candle bit 1430 during the polishing and/or repair process. The z-finder puck may emit a light, a sound, a vibration, a shock, and/or some combination thereof when the candle bit 1430 has come into contact with the z-finder puck. Additionally, and/or alternatively, the z-finder puck may emit the light, sound, vibration, shock, and/or some combination thereof when the candle bit 1430 comes into contact with the s-finder puck with sufficient pressure for executing and performing the polishing and/or repair process. The sufficient pressure may be determined by an amount of compression of the candle bit or an end-mounted sponge on the candle bit (e.g., approximately 1 to 2.5 mm of compression, such as 1.5, 1.8, 2 mm or a range defined by any two of the foregoing values). Additionally, and/or alternatively, the sufficient pressure may be determined by pounds (lbs) of downward force (e.g., approximately 5 to 8 lbs of downward force, such as 5.5, 6, 6.5, 7, 7.5 lbs or a range defined by any two of the foregoing values).

The CNC machine may lower the candle bit 1430 in pre-determined increments, such as increments of approximately 0.1-0.5 mm. For example, the CNC machine may lower the candle bit 1430 in increments of 0.1 mm, 0.2 mm, 0.3 mm, 0.4 mm or a range defined by any two of the foregoing values. The CNC machine may lower the candle bit 1430 until the candle bit 1430 or a sensor connected to the candle bit 1430 feels resistance from the z-finder puck. The candle bit 1430 will come into contact with the slick acrylic surface of the z-finder puck once the candle bit 1430 has been lowered enough to touch the z-finder puck (and feel resistance from contacting the puck).

The z-height of the device 1420 may be calibrated with a single touch-off point on the device (such as, for example, the home position 1455). Additionally, and/or alternatively, the z-height of the device 1420 may be calibrated in multiple places on the surface of the device 1420. For example, after calibrating the z-height by placing the z-finder puck at the home position 1455, the z-finder puck may be placed in a second, different position on the surface of the device 1420. The process of lowering the candle bit 1430 toward the z-finder puck may then be repeated. At each point, the z-height will be determined when the candle bit 1430 (or a sensor attached to or in communication with the candle bit) feels resistance by the z-finder puck.

Calibrating the z-height in multiple places beneficially ensures the device 1420 is level for a polishing process. In some of the described embodiments, free-floating mounts are used to mount the device 1420 to the platform 1415. The z-height of the device 1420 once it has been placed on the free-floating mounts may be calibrated using the z-finder puck to ensure the free-floating mounts are securing the device 1420 to the platform 1415 in a level manner for uniform and efficient polishing of the surface of the device 1420. Calibrating the z-height in multiple places is also beneficial as some devices have more than one z-height (or z zero). In some embodiments, calibrating the z-height in multiple places enables generation of a map of the device's surface and its z-height variations. This map may be used during the polishing and/or repair process to ensure the candle bit 1430 (and any end-mounted sponges) are polishing the device with a proper and adequate pressure. The map may be used to enable automatic adjustments to the applied pressure (e.g., automatic adjustment of RPMs) during the polishing and/or repair process. The map may be stored to a client and/or device profile upon completion of the polishing and/or repair process. The map may be used as an input variable for a subsequent polishing and/or repair process.

In some embodiments, the z-height of the device 1420 is calibrated while the candle bit 1430 is rotating slowly. Such rotation may also cause the puck to slowly rotate during the calibration process. Rotating the candle bit 1430, and the puck, during a calibration process enables multiple calibration readings, which reduces the margin of error for any one calibration process. Additionally, rotating the candle bit 1430 during the calibration process enables the calibration of the z-height to account for any variations in the surface of the candle bit 1430 (or any variations in the surfaces of the puck). That is, calibrating the z-height while the candle bit 1430 is rotating enables a user or the CNC machine to identify if the candle bit 1430 or the puck itself is not level, which would result in an inconsistent polish of the surface of the device 1420. Upon such identification, the user could switch out the non-level element (either the candle bit 1430 or the puck) and repeat the calibration of the z-height of the device. In this way, the surface of the device 1420 may be uniformly polished. In some embodiments, the CNC machine may be equipped with photoelectric sensors that use a laser beam to ensure the device 1420 is level prior to a polishing process. Any break in the path of the laser beam would be reported to a user of the CNC machine that the device 1420 is not level. The user may then calibrate the z-height of the device in multiple areas to level the device.

In some embodiments, a z-height of the device 1420 may be calculated, calibrated and adjusted in real-time or “on the fly.” For example, a z-controller may monitor the RPM of the candle bit 1430, which is being caused to rotate by the CNC machine. RPM may be a good indicator of resistance or pressure applied to the surface of the device 1420 by the candle bit 1430. The resistance or pressure applied to the surface of the device 1420 may be a function of a calculated and calibrated z-height of the device. A faster RPM may indicate the candle bit 1430 is not sufficiently in contact with the surface of the device 1420 or is not applying enough pressure to the surface of the device 1420. This would result in insufficient polishing of the device 1420 (i.e., there are still scratches present) and/or an increase in length of the polishing process. The faster RPM indicates the z-height is too high and the candle bit 1430 should be lowered closer to the device 1420. A slower RPM may indicate the candle bit 1430 is applying too much pressure to the surface of the device 1420, which may undesirably crack the surface of the device 1420. In some embodiments, the system and/or the CNC machine may determine the proper RPM based on the calibration of multiple z-heights and the device's schematics or dimensions.

In some embodiments, a pressure of the candle bit 1430, and/or an end-mounted applicator mounted on the candle bit 1430, may be calibrated using one or more pressure tabs. FIG. 36 illustrates examples of pressure tabs that may be used in determining the pressure of the candle bit 1430 that is applied to the surface of the device 1420. One or more pressure tabs may be placed on the surface of the device 1420. The CNC machine may lower the candle bit 1430 towards the pressure tab(s) (and, thus, towards the surface of the device 1420). When contacting the pressure tab(s) with a pressure appropriate for performing a polishing and/or repair process, the pressure tab(s) will break.

For example, a pressure tab may be calibrated to correspond with a specific pressure or pressure set that, when applied to the pressure tab, causes the pressure tab to break. This will signal to the user and/or the CNC machine that the candle bit 1430 is being applied to the surface of the device 1420 with an appropriate pressure for the polishing and/or repair process. The CNC machine may then execute or perform the polishing and/or repair process. If the pressure tab does not break, the candle bit 1430 is applying inadequate pressure to the surface of the device for the polishing and/or repair process. The pressure of the candle bit 1430 may be increased, and the CNC machine may lower the candle bit 1430 toward the pressure tab(s) again. This process may be repeated until the appropriate and adequate pressure of the candle bit 1430 has been determined via breaking of the pressure tab(s).

In some embodiments, the pressure tabs include a neck connecting two portions of the pressure tabs. In some embodiments, the neck is approximately 0.5 mm to 2.5 mm in width, such as 1 mm, 1.5 mm, 2 mm, or a width defined by any two of the foregoing values. The pressure tab may be placed on the surface of the device, and the candle bit may be lowered onto a first portion of the pressure tab. A second portion of the pressure tab remains free and is configured to be tugged or pulled from the first portion. If the candle bit is lowered onto the first portion with sufficient pressure (e.g., 1 pound of downward force), when the second portion is tugged or pulled, the neck will break. This breakage indicates to a user and/or the CNC machine what pressure the candle bit needs to apply to a surface of a device. If the candle bit is lowered onto the first portion with insufficient pressure, when the second portion is tugged on, the neck will not break and the first portion will be dragged around the surface of the device. The candle bit can then be lowered onto the first portion again, with a greater pressure. The tugging action can be repeated until the neck breaks and the first portion no longer drags around the surface of the device. The breakage of the neck enables a binary indication of whether the pressure applied by the candle bit is adequate. That is, the breakage of the neck indicates either yes, the pressure is adequate or no, the pressure is inadequate and the neck will not break. The pressure tabs may be constructed of paper, cardstock, plastic, foil, metal or any other suitable material.

The pressure of the candle bit 1430 may be monitored, detected and/or adjusted throughout the polishing and/or repair process. For example, the candle bit 1430 and/or the CNC machine may be equipped with an RPM counter which may be configured to monitor and/or detect the RPM of the candle bit 1430 during the polishing and/or repair process. When the RPMs detected do not satisfy a threshold value (e.g., approximately 1200 to 1800 RPMs) for a given location and z-height of the device, the system (e.g., the CNC machine) may automatically adjust the RPMs of the candle bit 1430 to satisfy the threshold value.

When the RPMs are, for example, below the threshold value, the candle bit 1430 may be applying too much pressure to the surface of the device. This may result in undesirable cracking or scratching of the device. When the RPMs are, for example, above the threshold value, the candle bit 1430 may not be applying enough pressure to the surface of the device. This may result in an insufficient polishing and/or repair process, where scratches may be left on the surface of the device. Monitoring and detecting the RPMs of the candle bit 1430, in conjunction with knowledge of the varying z-heights of the device, enables the system to automatically adjust the RPMs as needed to ensure the device is fully and properly polished and/or repaired.

Calibration of the z-height of the staging area 1410 and the platform 1415, and/or the z-height of the device 1420, enables the CNC machine to move the candle bit 1430 an appropriate height above the device 1420 in order to contact the surface of the device 1420 with an appropriate pressure for performing a polishing and/or repair process. If the candle bit 1430 is lowered onto the device 1420 and too much pressure is applied, the screen of the device 1420 may be polished too much and might even potentially crack. If the candle bit 1430 is lowered onto the device 1420 and too little pressure is applied, a scratch 1425 will be inadequately polished and/or repaired.

Returning to FIGS. 14A and 14B, in the application stage 1450, the candle bit 1430 is moved to a home position 1455 above the device 1420. In some cases, the candle bit 1430 is moved to the home position 1455 simultaneously with the calibration of the z-height of the device 1420. In some cases, the candle bit 1430 is moved to the home position 1455 after calibration of the z-height of the device 1420 using the touch-off groove 1480. In some cases, the candle bit 1430 is moved to the home position 1455 after calibration of the z-height of the device 1420 using a z-finder puck—electronic or otherwise. The home position 1455 can optionally be a predetermined positioned that is determined based on the known attributes or dimensions of the device 1420. For instance, the home position 1455 can be located at a top right corner of the device, a top left corner, a bottom left corner, a bottom right corner, a substantially center area, or any other selected area of the device 1420.

In some cases, the CNC machine includes a sensor 1460, such as perhaps an optical sensor or an IR sensor that can detect the edges of the device 1420. Based on the detected edges, the embodiments can then select a start or home position to begin the polishing process. In some cases, the sensor 1460 is a thermal imaging camera. In some cases, the sensor 1460 is a pressure sensor or RPM counter. In some cases, the sensor 1460 may include more than one sensor, such as 2, 3, 4, 5, or 6 sensors. In some cases, the sensor 1460 may include a camera or a photodetector. In some cases, detection of the edges of the device 1420 may trigger a change in the RPMs and/or applied pressure of the candle bit 1430. In some cases, the edges of the device may also be determined and/or confirmed by the sensor 1460 after accessing the device's 1420 dimension from a local and/or remote database. In some cases, the sensor 1460 may detect edges of multiple devices 1420 in an array of devices 1420 that are to be polished. Detection of the edges of multiple devices 1420 enables selecting a start or home position for each device 1420 in the array.

In some cases, openings on the device, such as speakers, microphones, buttons, and so on, can be taped over in order to prevent the paste from being lodged in those openings. Therefore, the preparation steps can also include taping over certain areas of the device. In some cases, openings on the device may be covered with a UV curing resin that is painted or otherwise applied to the openings of the device and can be peeled off after a polishing and/or repair process.

The embodiments cause the CNC machine to begin to rotate 1465 the candle bit 1430, either in a clockwise direction or a counterclockwise direction. In some cases, the rotation 1465 includes both clockwise and counterclockwise movements. For instance, the candle bit can be rotated a set amount in a clockwise direction and then rotated a set amount in a counterclockwise direction and then rotated again a set amount in a clockwise direction in a repeated manner when polishing the device. In some cases, the set amount can be a 1/16 rotation of the candle bit or multiples of a 1/16 rotation (e.g., 2* 1/16, 3* 1/16, 4* 1/16, 5* 1/16, 6* 1/16, 7* 1/16, 8* 1/16, 9* 1/16, 10* 1/16, 11* 1/16, 12* 1/16, 13* 1/16, 14* 1/16, 15* 1/16, 16* 1/16). In some cases, the backward and forward movement can help facilitate “rubbing in” the paste into the screen. One will appreciate how in scenarios where the rotation direction repeatedly changes, then the rotation rate of the candle bit will be significantly slower than a scenario where the candle bit rotates in a single direction at potentially between 1,000 RPM to 2,500 RPM.

The candle bit 1430 is then lowered (and/or the staging area 1410 is raised) until the sponge on the candle bit 1430 makes contact with the screen of the device 1420. The depth or position of the candle bit 1430 can be set to any depth to result in the sponge being more or less pressed against the screen. Such depth may be determined using the pressure tabs.

With the candle bit 1430 rotating, the embodiments then cause the CNC machine to move the candle bit 1430 across the screen of the device in a selected pattern 1470. The pattern 1470 can be an existing pattern or it can be custom set by a user before operation. Notice, in FIG. 14A, the pattern 1470 is generally a zig-zag pattern across the length of the device 1420. Completion of the pattern 1470 constitutes a “pass” of the candle bit 1430 over the device 1420. In some cases, the sensor 1460 is a thermal imaging camera that detects a temperature of the surface of the device 1420 while the candle bit 1430 is moving in the pattern 1470. Further details on this thermal aspect will be provided later.

In some embodiments, the CNC machine may be configured to cause the candle bit 1430 to make multiple passes over the device 1420 in order to polish and/or repair the device 1420. In some embodiments, before the start of a new pass, the sponge is again loaded or coated with paste, using the raising, lowering, and/or dipping operations mentioned previously. In some cases, the sponge is dipped into the water 1440 before new paste 1435 is coated on the sponge. In some cases, the sponge is dipped into the water 1440 and then a new pass is performed without using additional paste. In some embodiments, a pass is performed just on the detected edges of the device. The pass may be performed by a sponge specifically designed for polishing edges of the device, such as a sponge having more give than a sponge used for polishing flat surfaces.

FIG. 14A shows a scenario where a second pass 1475 is being performed using a new pattern 1475A. In some cases, a new pattern is performed on a subsequent pass while in other cases the same pattern is repeated for multiple passes.

By buffing the paste into the screen of the device, the paste can be used to perform a number of operations. In a first scenario, the paste can be used to etch or remove a threshold amount of the screen material from the screen. For instance, anywhere from 0 nm up to about 6 nm or 7 nm or perhaps even 8 nm of screen material can be removed. For example, 0.1 nm, 0.5 nm, 1nm, 3 nm, 4 nm, 6 nm, 8 nm of screen material, or a range defined by any two of the foregoing values, may be removed. If the screen included a scratch, then the removal of the screen material results in the entire screen being lowered or reduced by 0-8 nm, thereby eliminating the scratch via a removal process.

In a second scenario, the paste can be used to fill in the scratch such that the paste causes the scratch to now be flush with the remaining portions of the screen. That is, a small amount of the paste can be deposited or buffed into the scratch and caused to remain in that scratch in order to result in a smooth and level screen.

FIG. 14B shows a third pass 1480 of the candle bit 1430 over the screen, where a third pattern 1485A is followed. Finally, in the finishing stage 1490, the sponge is removed from the screen, by raising the candle bit 1430 and/or by lowering the staging area 1410. Notice, the device's screen is now scratch-free 1495 as a result of performing the buffing operations using the paste.

In some cases, the CNC machine moves the candle bit 1430 to a specific location where a hook can snag on the sponge, thereby removing the sponge from the hook-and-loop fastener attached to the cushion portion of the candle bit. In some cases, the finishing stage 1490 includes issuing an alert to a user to inform the user that the user should wipe off the screen with a clean rag in order to remove any paste particles or residue. In some cases, the finishing stage 1490 includes issuing an alert to inform the user that the paste containers should be replaced with a new container. In some embodiments, the finishing stage 1490 includes dipping the sponge into water one or more times, potentially rotating the sponge while the sponge is in the water, and then applying the wet sponge to the screen in order to perform a final cleaning of the screen.

In some cases, the embodiments can auto-calibrate the Z axis to potentially facilitate the automatic installation and removal of the sponge from the candle bit. Furthermore, the embodiments can be configured to provide a platform for the sponge to rest and get pressed onto and optionally removed from the candle bit. In some cases, prior to applying the polishing substance (e.g., paste) onto the sponge, the sponge is dipped into water. This process can be repeated any number of times. To illustrate, the embodiments can apply water to the sponge, apply the paste to the sponge, wipe or polish the paste onto the screen with the sponge, and then repeat that process any number of times.

In some cases, the process flow 1400 includes a pre-preparation stage which includes removal of any oleophobic coatings present on a device prior to performing the polishing and/or repair process. Most modern devices (smartphones, tablets, watches, etc.) include or feature an oleophobic coating (i.e., an oil-repellant coating) that protects the screen, improves smoothness, and reduces fingerprints. Presence of this coating during a polishing and/or repair process can inhibit adequate polishing and/or repair of scratches on the screen. That is, the paste used in a polishing and/or repair process may be unable to penetrate the oleophobic coating to sufficiently contact the screen of the device in order to polish and/or repair the screen. Removal of the oleophobic coating ensures the paste sufficiently contacts the screen of the device in order to polish and/or repair the screen.

In some cases, the pre-preparation stage includes removal of the oleophobic coating through application of a pre-treatment solution. The pre-treatment solution may contain surfactants and/or other oleophobic removing materials. In some embodiments, the pre-treatment solution may be the paste used in the polishing and/or repair process. In some embodiments, the paste may be diluted to an appropriate concentration for removing the oleophobic coating. The pre-treatment solution may be a liquid, a spray, wipes, or other appropriate phase for application to a screen of the device. For example, the pre-treatment solution may be pre-soaked wipes, pre-soaked sponges, or melamine sheets. The pre-treatment solution may be applied to a screen of the device to be polished and/or repaired, thereby removing the oleophobic coating present on the screen of the device. The pre-treatment solution may be applied to the screen of the device and then “rubbed in” using, for example, a sheet such as a melamine sheet or microfiber cloth. After removal of the oleophobic coating, a polishing and/or repair process of the device, such as those described herein, may be performed by the CNC machine.

In some cases, the candle bit 1430 of the CNC machines is coated with the pre-treatment solution and applies the pre-treatment solution to the screen of the device. For example, the CNC machine moves the candle bit 1430 to a location above the pre-treatment solution, which may be in a reservoir of the staging area 1410. The CNC machine then causes the candle bit 1430 to be dipped into the pre-treatment solution. This dipping action can occur by lowering the candle bit 1430 into the pre-treatment solution and/or by raising the staging area 1410 upwards to contact the pre-treatment solution with the candle bit 1430. In some cases, the candle bit 1430 is rotated at a slow rate, such as between 1 RPM to 60 RPM, while immersed in the pre-treatment solution in order to fully or substantially coat the surface area of the sponge with the pre-treatment solution.

The CNC machine then raises the candle bit 1430 from the pre-treatment solution and positions the candle bit 1430 over the screen of the device 1420. The embodiments cause the CNC machine to begin to rotate 1465 the candle bit 1430. The rotating candle bit 1430 is then lowered (and/or the staging area 1410 is raised) until the sponge on the candle bit 1430 makes contact with the screen of the device 1420. The depth or position of the candle bit 1430 can be set to any depth to result in the sponge being more or less pressed against the screen. Such depth may be determined using the pressure tabs.

With the candle bit 1430 rotating, the embodiments then cause the CNC machine to move the candle bit 1430 across the screen of the device 1420 in a selected pattern. The pattern can be an existing pattern or it can be custom set by a user before operation. Moving the candle bit 1430 in the selected pattern across the screen of the device 1420 removes the oleophobic coating from the screen of the device 1420. In some embodiments, the CNC machine may be configured to cause the candle bit 1430 to make multiple passes over the device 1420 in order to fully remove the oleophobic coating. In some embodiments, a user may remove the oleophobic coating prior to placing the device in a staging area and/or platform of the CNC machine for a polishing and/or repair process.

In some embodiments, the candle bit 1430 and/or the CNC machine is equipped with a sensor to detect whether the oleophobic coating has fully been removed from the screen of the device. In some embodiments, the sensor is configured to detect beading of the polishing paste and/or water applied to the surface of the screen. The sensor may additionally, and/or alternatively, detect a diameter of a water droplet on the screen of the device. The water droplet may have a known first diameter when an oleophobic coating is present on the screen of the device, and a known second diameter when there is no oleophobic coating on the screen. The sensor may detect the first and/or second diameters, thereby detecting whether the oleophobic coating has been fully removed. When beading is detected, the CNC machine and/or user may be notified that the oleophobic coating has insufficiently been removed. Optionally, the CNC machine may then perform the pre-preparation stage again, fully removing the oleophobic coating. The sensor may be a camera, an electronic eye sensor, or other appropriate sensor. In some embodiments, the sensor is the same sensor that identifies and characterizes scratches on the device.

In some cases, the process flow 1400 includes a conclusion stage, where an oleophobic coating is re-applied to the screen of a device 1420 after a polishing and/or repair process has been performed and completed. Similar to removing the oleophobic coating, in some cases, the candle bit 1430 of the CNC machines is coated with the oleophobic coating and applies the oleophobic coating to the screen of the device 1420.

For example, the CNC machine moves the candle bit 1430 to a location above the oleophobic coating, which may be in a reservoir of the staging area 1410. The CNC machine then causes the candle bit 1430 to be dipped into the oleophobic coating. This dipping action can occur by lowering the candle bit 1430 into the oleophobic coating and/or by raising the staging area 1410 upwards to contact the oleophobic coating with the candle bit 1430. In some cases, the candle bit 1430 is rotated at a slow rate, such as between 1 RPM to 60 RPM, while immersed in the oleophobic coating in order to fully or substantially coat the surface area of the sponge with the oleophobic coating.

The CNC machine then raises the candle bit 1430 from the oleophobic coating and positions the candle bit 1430 over the screen of the device 1420. The embodiments cause the CNC machine to begin to rotate 1465 the candle bit 1430. The rotating candle bit 1430 is then lowered (and/or the staging area 1410 is raised) until the sponge on the candle bit 1430 makes contact with the screen of the device 1420. The depth or position of the candle bit 1430 can be set to any depth to result in the sponge being more or less pressed against the screen. Such depth may be determined using the pressure tabs.

With the candle bit 1430 rotating, the embodiments then cause the CNC machine to move the candle bit 1430 across the screen of the device 1420 in a selected pattern. The pattern can be an existing pattern or it can be custom set by a user before operation. Moving the candle bit 1430 in the selected pattern across the screen of the device 1420 applies the oleophobic coating to the screen of the device 1420. In some embodiments, the CNC machine may be configured to cause the candle bit 1430 to make multiple passes over the device 1420 in order to apply the oleophobic coating.

Additionally, and/or alternatively, the oleophobic coating may applied to the device using a different applicator head than the candle bit 1430. For example, the candle bit 1430 may be swapped out for a sprayer or mister attachment. The sprayer or mister attachment may spray or mist the oleophobic coating onto the surface or screen of the device. In some embodiments, the sprayer or mister attachment is positioned approximately 12 inches from the surface or screen of the device. For example, the sprayer or mister attachment may be positioned 7, 9, 10, 11, 13, 14, or 15 inches from the surface or screen of the device, or a distance defined by any two of the foregoing values. In some embodiments, the applied oleophobic coating is allowed to dry for a time period, such as approximately 5 to 12 hours.

### Another Example Method

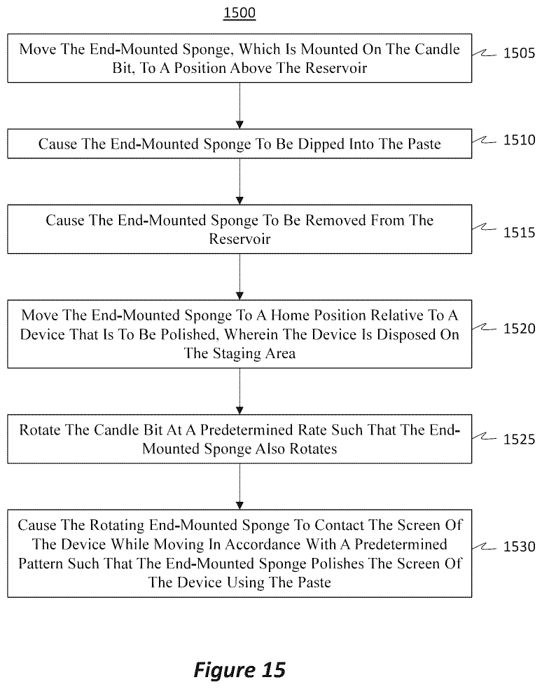

FIG. 15 shows another example method 1500 for polishing and/or repairing the screen on a device. Method 1500 can be implemented via a computer system that includes a CNC machine equipped with a candle bit and a staging area. The candle bit includes an end-mounted sponge, and the staging area includes a reservoir that includes a paste. In some cases, the staging area includes a platform comprising free-floating mounts. A device can be positioned on the free-floating mounts of the platform. As a consequence, the device can be elevated in a free-floating manner or propped up in a free-floating manner to ensure that the device is positioned levelly (e.g., any backside cameras will not topple the device or cause the device to lie in a non-level manner).

Act 1505 involves moving the end-mounted sponge, which is mounted on the candle bit, to a position above the reservoir. For instance, the preparation stage 1405 of FIG. 14A shows how the candle bit 1430 can be moved to a position above the paste 1435. Act 1505 can be performed by the computer system instructing the CNC machine to perform this movement.

Act 1510 includes causing the end-mounted sponge to be dipped into the paste. This “dipping” action can be performed by lowering the candle bit into the paste reservoir and/or by raising the staging platform to cause the reservoir to contact the sponge. Act 1510 can be performed by the computer system instructing the CNC machine to perform this dipping operation. In some cases, the sponge is rotated in a single direction or perhaps back and forth while immersed in the paste.

Notably, the paste can be a scratch removing paste. When the scratch removing paste is buffered onto the device's screen, the process of buffing or polishing the screen with the scratch removing paste can result in a threshold amount of the screen material being removed from the screen to thereby remove a scratch on the screen. The threshold amount can be anywhere from more than 0 nm up to about 8 nm of removed material. In some cases, the threshold amount of screen material that is removed is between 1 nm of screen material and 6 nm of screen material.

Act 1515 includes causing the end-mounted sponge to be removed from the reservoir. Removal can occur by raising the candle bit and/or by lowering the staging area. Act 1515 can be performed by the computer system instructing the CNC machine to perform this removal operation. When the candle bit is removed, the CNC machine can refrain from rotating the candle bit.

Act 1520 includes moving the end-mounted sponge to a home position relative to a device that is to be polished, where the device is disposed on the staging area. The application stage 1450 of FIG. 14A shows how the candle bit 1430 is moved to the home position 1455. Act 1520 may additionally include calibration of a z-height of the device or a pressure of the candle bit and/or the end-mounted applicator, as described above. Act 1520 can be performed by the computer system instructing the CNC machine to perform this movement.

Optionally, the home position can be a predetermined position that is selected based on known attributes, dimensions, or schematics of the device. Optionally, the home position can be a dynamically determined position based on an identified feature of the device. The identified feature can be detected using a sensor, such as an optical sensor or an infrared (IR) sensor. The identified feature can, for example, be a detected corner or corner region, a detected edge or edge region, or any other recognizable or detectable area of the device's screen.

Act 1525 involves rotating the candle bit at a predetermined rate such that the end-mounted sponge also rotates. Act 1525 can be performed by the computer system instructing the CNC machine to perform this rotation.

In some embodiments, the predetermined rate that the candle bit is rotated is between 1,000 RPM and 2,500 RPM. In some cases, the end-mounted sponge is affixed or attached to the candle bit via a hook-and-loop fastener connection and thus rotates with the candle bit.

Act 1530 includes causing the rotating end-mounted sponge to contact the screen of the device while moving in accordance with a predetermined pattern such that the end-mounted sponge polishes the screen of the device using the paste. FIGS. 14A and 14B show how the candle bit, and thus the sponge, can be moved in accordance with various different patterns in order to polish and repair the screen of a device.

Some embodiments can also determine a make and model of the device. Based on the determined make and model of the device, the embodiments can determine dimensions of the device. Furthermore, the embodiments can use the dimensions to determine the predetermined pattern (e.g., perhaps by scaling, rotating, or otherwise skewing an existing pattern to fit the dimensions of the device and/or perhaps by generating a new pattern) by which the rotating end-mounted sponge polishes the screen of the device. As an example, the embodiments might initially select a pattern designed for an 8 inch by 4 inch device. The embodiments might then modify this pattern by stretching, skewing, shrinking, rotating, or by some other manipulation so as to accommodate a device that is 7 inches by 3 inches. Some embodiments may include accessing a profile, such as a client and/or device profile. The profile may include a polishing and/or repair history of the device. Using the polishing and/or repair history of the device, the embodiments may determine or select a pattern by which the rotating end-mounted sponge polishes the screen of the device.

In some cases, a machine learning engine might generate a pattern based on identified areas where a scratch is. For example, it may be the case that areas within a threshold distance of a scratch are polished while areas outside of the threshold distance are not polished or are not polished as much as the scratched areas (e.g., perhaps the unscratched areas are polished once while the scratched areas are polished multiple times or perhaps the unscratched areas are polished “x” amount of time while the scratched areas are polished “y” amount of time, where “y” is more than “x”). Based on the identification of the scratches, a machine learning algorithm can generate a customized pattern that may be used to polish some, but not all, of the areas of the screen. For example, the machine learning algorithm may generate a “spot polish” pattern. In some cases, a user can design the pattern. In some cases, the machine learning algorithm can design the pattern and then trigger an alert requesting permission to use the generated pattern. In some embodiments, the machine learning algorithm may generate the customized pattern based on information stored and accessed in the client and/or device profile.

In some cases, multiple patterns might be selected, with a new pattern being used for each new pass performed by the end-mounted sponge. For instance, the process of moving the end-mounted sponge in accordance with the predetermined pattern to cause the end-mounted sponge to polish the screen of the device using the paste might include a number of sub-steps or actions. To illustrate, one action might involve causing the rotating end-mounted sponge to follow a first pattern to apply the paste to an entirety or to at least a selected portion of the device. After completion of the rotating end-mounted sponge following the first pattern, the embodiments can cause the rotating end-mounted sponge to follow a second pattern to further polish the screen of the device by moving the rotating end-mounted sponge to various other positions across the screen.

Some devices include curved edges. Some embodiments modify the depth of the candle bit when operating near the edge regions so as to ensure that the entirety of the curved edge is polished. Some embodiments can cause the CNC machine to angle the candle bit and/or the staging area when polishing the curved edge. In some embodiments, the angle is relative to the z-axis or dimension. Some embodiments may polish the edges only; some embodiments may polish a back surface of a device and/or a camera or lenses on the back surface of the device.

### Additional Views Of CNC Machine

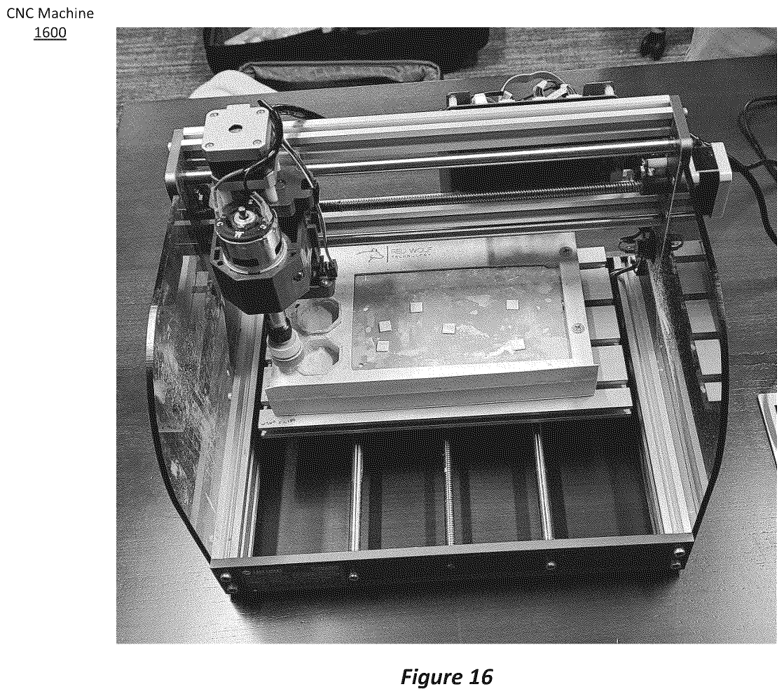

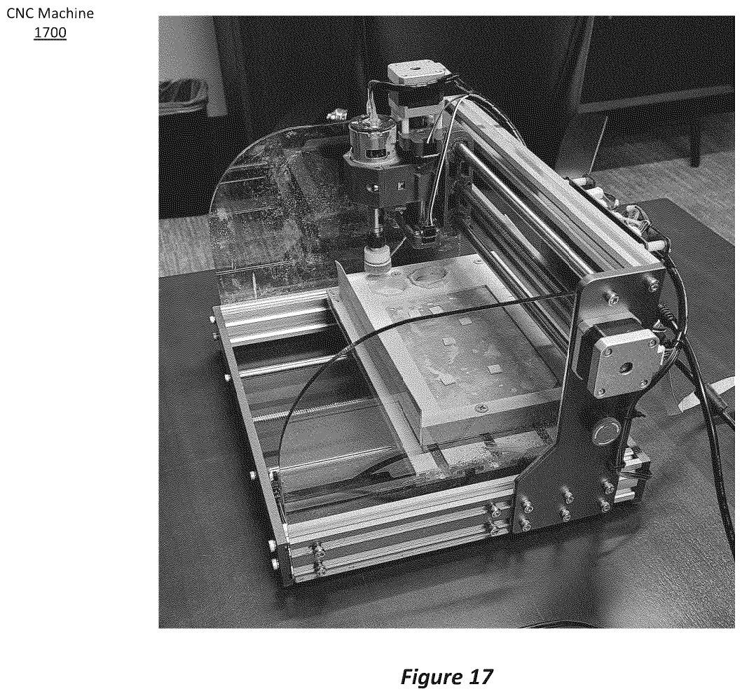

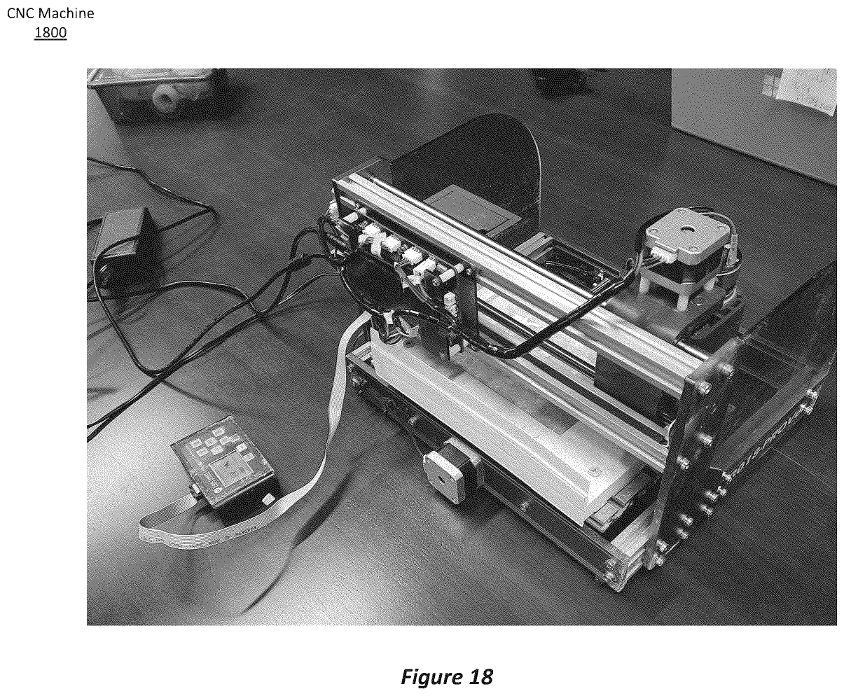

FIGS. 16 to 21 illustrate various additional perspective views of the CNC machine and the various other parts described herein. Turning first to FIG. 16, this figure shows a front angled view of the CNC machine 1600, including the staging area, platform, candle bit, sponge, and the reservoirs. FIG. 17 shows a side angled view of the CNC machine 1700. FIG. 18 shows a rear angled view of the CNC machine 1800. In some embodiments, a tethered control device can be used to facilitate control of the CNC machine.

In some embodiments, one controller, such as perhaps a phone, computer, or some other device, can control any number of CNC machines. For instance, the architecture can include multiple CNC machines, and multiple devices can be polished simultaneously with those CNC machines. In some cases, multiple devices can be housed or disposed on one CNC machine. That one CNC machine can then polish the multiple devices.

FIG. 19A shows the staging area 1900 and the platform 1905, which includes various floating mounts (e.g., floating mount 1910). The floating mounts 1910 may be silicone strips or pieces, rubber strips or pieces, grip tape or a similar non-adhesive, non-skid material. Additionally, and/or alternatively, the floating mounts 1910 may include an adhesive. FIG. 19 also shows the reservoir 1915, in which a paste container or water can reside. Also shown are the candle bit 1920 and the sponge 1925. In some cases, the embodiments can use sponges having different granularity levels or coarseness levels. In some cases, sponges can have different colors to indicate their respective coarseness levels.

Regarding coarseness, a relatively high-coarseness sponge might be used for a first pass over a device, a relatively medium-coarseness sponge might be used for a second pass over the device, and a relatively low-coarseness sponge might be used for a third pass over the device. In some embodiments, a hook might be provided on the CNC machine. The CNC machine can direct the sponge over to the hook, which will then snag the sponge and remove it from the candle bit 1920. In some cases, the CNC machine can then automatically install or place a new sponge on the candle bit 1920, such as by moving the candle bit 1920 to a different reservoir comprising new sponges. The CNC machine can cause the candle bit 1920 to contact a new sponge, and the hook-and-loop fasteners can connect to the sponge, thereby securing the sponge to the candle bit 1920.

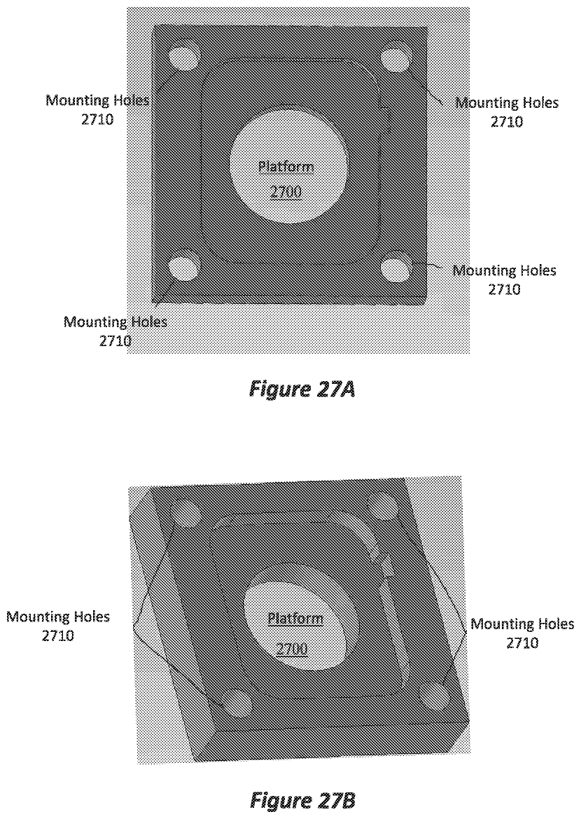

FIGS. 19B-C illustrate additional or alternative embodiments of the staging area 1900. FIGS. 19B-C include two reservoirs 1915 and an additional touch-off point 1920. The touch-off point 1920 may be used to calibrate the z-height of the platform during an auto-calibration process, such as that described above with respect to FIGS. 14A and 14B. FIG. 19B also includes mounting holes for securing an additional or alternative platform, such as the platform illustrated in FIGS. 27A-B. FIG. 19C includes a splash guard (such as splash guard 905 from FIG. 9) that may be removed for cleaning after a polishing and/or repair process.

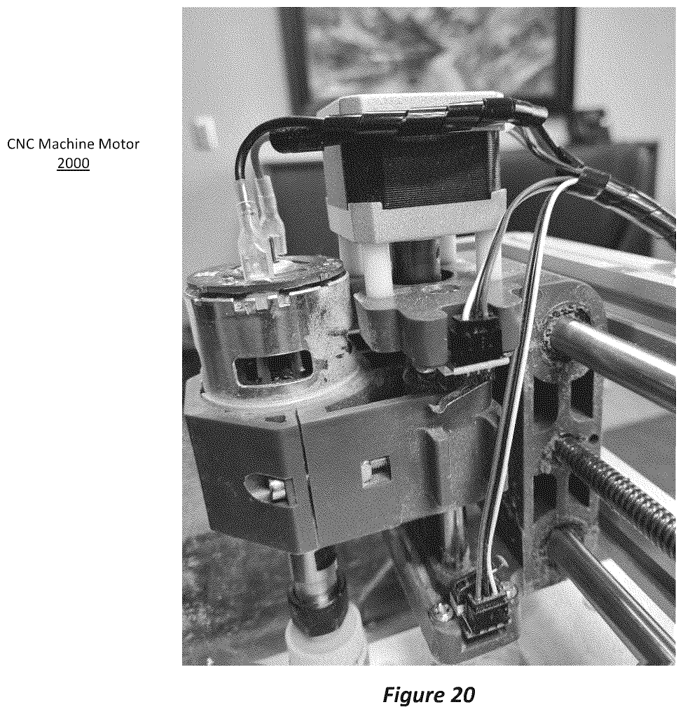

FIG. 20 shows an example of a CNC machine motor 2000, which can be any type of motor, without limit. In some cases, the CNC machine motor 2000 can rotate the candle bit in a clockwise direction and/or a counterclockwise direction. The CNC machine motor 2000 can rotate the candle bit at various different RPMs, including between 1 RPM and 10,000 RPM. When polishing the screen, it is preferred to rotate the candle bit between about 1,000 RPM and 2,000 RPM. When dipping the sponge into a reservoir so as to coat the sponge with the paste, it is often preferred to rotate the candle bit between about 1 RPM and about 60 RPM. In some cases, the range is between about 10 RPM and 30 RPM.

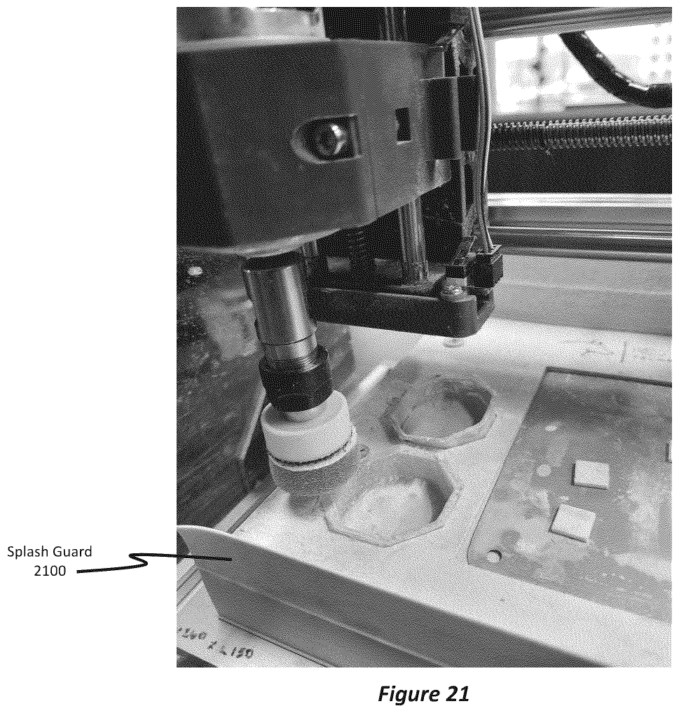

FIG. 21 shows another view of the splash guard 2100, which is provided to help eliminate or mitigate splash effects when the sponge is applied to the screen while rotating. The splash guard 2100 can optionally be as long as the staging platform. In some cases, the splash guard 2100 is anywhere between about 0.5 inches in height to about 4 inches in height. In some cases, the splash guard 2100 surrounds only a single side of the staging area. In some cases, the splash guard 2100 surrounds the entirety of the staging area, such as perhaps around a perimeter of the staging area.

In some cases, the splash guard 2100 includes a top or roof-like portion so as to fully encompass or envelope the staging area from all sides and from the top, such as in the form of a cube or some other volumetric shape. When in the form of an encompassing volumetric shape, the splash guard 2100 can be equipped with a door that provides access to an internal portion of the splash guard 2100 in order to place and remove a device, the paste containers, water, and/or the sponges.

### Another Example Method

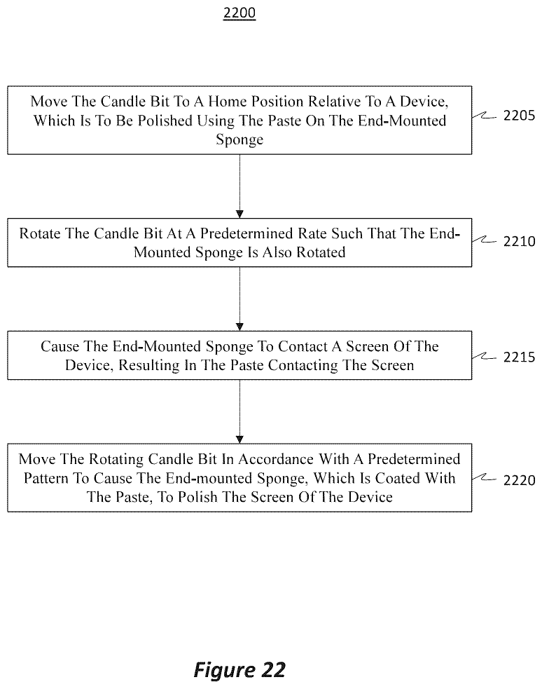

FIG. 22 shows a flowchart of an example method 2200 for polishing and/or repairing a device's screen. Method 2200 can be performed by a computer system comprising a CNC machine equipped with a candle bit and a staging area. In some cases, the candle bit includes an end-mounted sponge. In some cases, a paste is coated on the end-mounted sponge. In some cases, a device is disposed on a free-floating mount of a platform of the staging area.

Initially, method 2200 includes an act (act 2205) of moving the candle bit to a home position relative to the device, which is to be polished using the paste coated on the end-mounted sponge. Act 2205 can be performed by a combination of the computer system and the CNC machine. For instance, the computer system can control the CNC machine, and the CNC machine can perform the actual movement of the candle bit.

In some cases, the end-mounted sponge is pre-configured to be coated with the paste. For instance, the sponge can come in a package, and the sponge can be pre-soaked or pre-coated with the paste. The pre-soaked sponge can then be wrapped in the packaging. Once removed from the packaging, the pre-coated sponge can be installed on the candle bit.

In some cases, the end-mounted sponge is dipped in a container comprising the paste in order to coat the end-mounted sponge with the paste. This dipping motion or movement can be performed by the CNC machine moving the candle bit and/or the staging area in a manner so as to align the sponge with a paste container. The sponge can then be dipped into the paste container in order to coat the sponge with the paste.

Optionally, the “home” position is predetermined based on determined dimensions or attributes of the device. For example, a user can enter the make and model of the device in the UI mentioned earlier. Additionally, or alternatively, the make and model of the device can be automatically determined by capturing an image of the device and then identifying the device from the image, such as perhaps using machine learning. A query can then be performed using the make and model to determine the device's dimensions and schematics. Once the dimensions/schematics of the device are known, then a home location can be selected. The home location can also be referred to as a start position where the polishing procedure will start.

Optionally, the home position is determined using a sensor that senses a feature of the device. By way of example, the “feature” can be a corner, edge, camera, button, or any other detectable feature on the device. In some cases, a sticker or adhesive can be placed on the screen to mark a desired home location. The CNC machine can be equipped with a sensor that can detect the location of the sticker and can select that location as the home position. In some cases, the ticker can be removed prior to polishing. In some cases, the sticker might be sufficiently out of the way such that the sticker can remain during the polishing process.

The candle bit is then rotated (act 2210) at a predetermined rate such that the end-mounted sponge is also rotated. The CNC machine can rotate the candle bit based on variables entered at the UI, which is displayed by the computer system.

Act 2215 involves causing the end-mounted sponge to contact a screen of the device, resulting in the paste contacting the screen. Act 2215 can be performed by the computer system instructing the CNC machine to move the candle bit and/or the staging area in a manner to enable the sponge on the candle bit to contact the device's screen.

Act 2220 includes moving the rotating candle bit in accordance with a predetermined pattern to cause the end-mounted sponge, which is coated with the paste, to polish the screen of the device. Again, the combination of the computer system and the CNC machine perform this act. In some embodiments, the CNC machine moves the candle bit in an x direction and a y direction while the device is positioned on a staging platform. In some cases, the CNC machine can also move the staging platform in a z-dimension. Additionally, or alternatively, the CNC machine can move the candle bit in a z-dimension.

In some embodiments, the candle bit may be moved in multiple patterns and/or passes (see, for example, FIGS. 14A to 14C). For example, the candle bit may be moved in a first pass and pattern that is configured to polish edges of the device. The candle bit may be moved in a second pass and pattern that is configured to polish the surface (e.g., facial or planar) of the device. The candle bit may be moved in a third pass and pattern that is also configured to polish the surface of the device. The second pass may polish the surface in orthogonal directions (e.g., an x- and y-direction), while the third pass may polish the surface in a vertical or z-direction. The candle bit may be moved in a fourth pass and pattern that is configured to polish the edges and/or corners to the device.

FIG. 23 illustrates an example computer system configured to perform any of the disclosed operations. FIG. 23 will be discussed in more detail later.

### Another Example Method

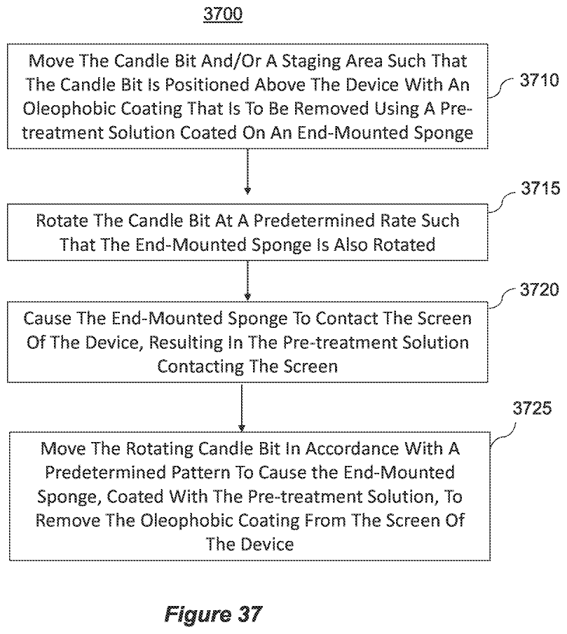

FIG. 37 shows a flowchart of an example method 3700 for removing an oleophobic coating from a device's screen. Method 3700 can be performed by a computer system comprising a CNC machine equipped with a candle bit and a staging area. In some cases, the candle bit includes an end-mounted sponge. In some cases, a pre-treatment solution is coated on the end-mounted sponge. In some cases, a device is disposed on a free-floating mount of a platform of the staging area.

Initially, method 3700 includes an act (act 3710) of moving the candle bit to a position above the device, which has an oleophobic coating that will be removed using the pre-treatment solution coated on the end-mounted sponge. Act 3710 can be performed by a combination of the computer system and the CNC machine. For instance, the computer system can control the CNC machine, and the CNC machine can perform the actual movement of the candle bit.

In some cases, the end-mounted sponge is pre-configured to be coated with the pre-treatment solution. For instance, the sponge can come in a package, and the sponge can be pre-soaked or pre-coated with the pre-treatment solution. The pre-soaked sponge can then be wrapped in the packaging. Once removed from the packaging, the pre-coated sponge can be installed on the candle bit. In some embodiments, the end-mounted sponge is the same end-mounted sponge used in a subsequent polishing and/or repair process. In some embodiments, the end-mounted sponge is different than the end-mounted sponge used in a subsequent polishing and/or repair process. If the end-mounted sponges are different, the CNC machine may be configured to change or swap the end-mounted sponges mounted to the candle bit.

For example, the CNC machine may be equipped with a hook and a sponge-storage location. When the pre-preparation stage has been completed, and the system needs to start a polishing and/or repair process, the CNC machine may move the candle bit to a specific location where the hook can snag on the sponge, thereby removing the sponge from the hook-and-loop fastener attached to the cushion portion of the candle bit (see FIGS. 10 to 13 and 25). The CNC machine may then move the candle bit to the sponge-storage location to attach another end-mounted sponge to the candle bit for performing a polishing and/or repair process.

In some cases, the end-mounted sponge is dipped in a container comprising the pre-treatment solution in order to coat the end-mounted sponge with the pre-treatment solution. This dipping motion or movement can be performed by the CNC machine moving the candle bit and/or the staging area in a manner so as to align the sponge with a pre-treatment solution container. The sponge can then be dipped into the pre-treatment solution container in order to coat the sponge with the pre-treatment solution.

The candle bit is then rotated (act 3715) at a predetermined rate such that the end-mounted sponge is also rotated. The CNC machine can rotate the candle bit based on variables entered at the UI, which is displayed by the computer system.

Act 3720 involves causing the end-mounted sponge to contact a screen of the device, resulting in the pre-treatment solution contacting the screen. Act 3720 can be performed by the computer system instructing the CNC machine to move the candle bit and/or the staging area in a manner to enable the sponge on the candle bit to contact the device's screen.

Act 3725 includes moving the rotating candle bit in accordance with a predetermined pattern to cause the end-mounted sponge, which is coated with the pre-treatment solution, to remove the oleophobic coating from the screen of the device. Again, the combination of the computer system and the CNC machine perform this act. In some embodiments, the CNC machine moves the candle bit in an x direction and a y direction while the device is positioned on a staging platform. In some cases, the CNC machine can also move the staging platform in a z-dimension. Additionally, or alternatively, the CNC machine can move the candle bit in a z-dimension.

As described herein, the candle bit 1430 and/or the CNC machine may be equipped with a sensor to detect whether the oleophobic coating has fully been removed from the screen of the device. In some embodiments, the sensor is configured to detect beading of the polishing paste and/or water applied to the surface of the screen. In some embodiments, the CNC machine and/or the user will be notified when there is beading of the polishing paste and/or water, and the pre-preparation stage needs to be repeated.

FIG. 23 illustrates an example computer system configured to perform any of the disclosed operations. FIG. 23 will be discussed in more detail later.

### Another Example Method

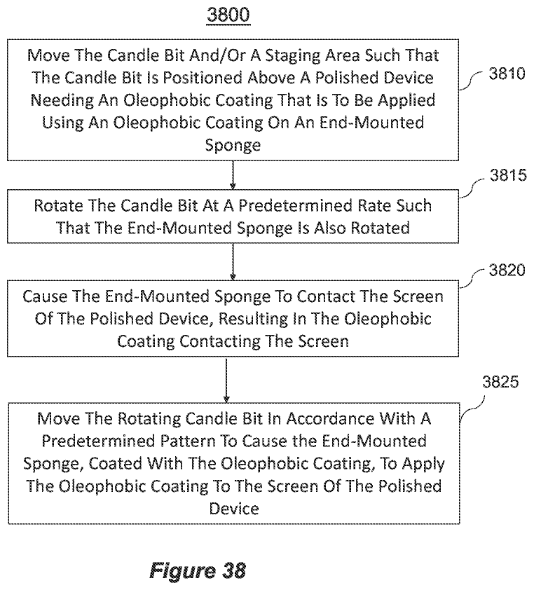

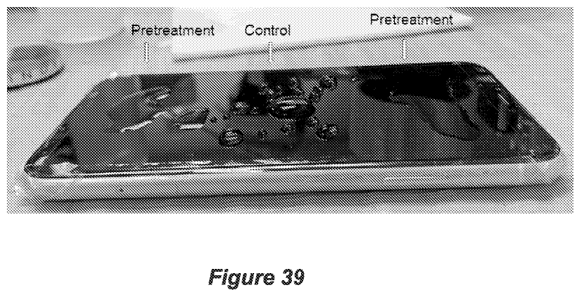

FIG. 38 shows a flowchart of an example method 3800 for applying an oleophobic coating to a device's screen. Method 3800 can be performed by a computer system comprising a CNC machine equipped with a candle bit and a staging area. In some cases, the candle bit includes an end-mounted sponge. In some cases, an oleophobic coating is coated on the end-mounted sponge. In some cases, a device is disposed on a free-floating mount of a platform of the staging area.

Initially, method 3800 includes an act (act 3810) of moving the candle bit to a position above the polished device, which is to have an oleophobic coating be applied using the oleophobic coating coated on the end-mounted sponge. The polished device will have gone through a polishing and/or repair process such as those described herein. Act 3810 can be performed by a combination of the computer system and the CNC machine. For instance, the computer system can control the CNC machine, and the CNC machine can perform the actual movement of the candle bit.

In some cases, the end-mounted sponge is pre-configured to be coated with the oleophobic coating. For instance, the sponge can come in a package, and the sponge can be pre-soaked or pre-coated with the oleophobic coating. The pre-soaked sponge can then be wrapped in the packaging. Once removed from the packaging, the pre-coated sponge can be installed on the candle bit.

In some cases, the end-mounted sponge is dipped in a container comprising the oleophobic coating in order to coat the end-mounted sponge with the oleophobic coating. This dipping motion or movement can be performed by the CNC machine moving the candle bit and/or the staging area in a manner so as to align the sponge with an oleophobic coating container. The sponge can then be dipped into the oleophobic coating container in order to coat the sponge with the oleophobic coating. In some embodiments, the end-mounted sponge is the same end-mounted sponge used in a previous polishing and/or repair process. In some embodiments, the end-mounted sponge is different than the end-mounted sponge used in a previous polishing and/or repair process. If the end-mounted sponges are different, the CNC machine may be configured to change or swap the end-mounted sponges mounted to the candle bit, as described herein.

The candle bit is then rotated (act 3815) at a predetermined rate such that the end-mounted sponge is also rotated. The CNC machine can rotate the candle bit based on variables entered at the UI, which is displayed by the computer system.

Act 3820 involves causing the end-mounted sponge to contact a screen of the device, resulting in the oleophobic coating contacting the screen. Act 3820 can be performed by the computer system instructing the CNC machine to move the candle bit and/or the staging area in a manner to enable the sponge on the candle bit to contact the device's screen.

Act 3825 includes moving the rotating candle bit in accordance with a predetermined pattern to cause the end-mounted sponge, which is coated with the oleophobic coating, to apply the oleophobic coating to the screen of the polished device. Again, the combination of the computer system and the CNC machine perform this act. In some embodiments, the CNC machine moves the candle bit in an x direction and a y direction while the device is positioned on a staging platform. In some cases, the CNC machine can also move the staging platform in a z-dimension. Additionally, or alternatively, the CNC machine can move the candle bit in a z-dimension.

FIG. 23 illustrates an example computer system configured to perform any of the disclosed operations. FIG. 23 will be discussed in more detail later.

### Additional Views

Attention will now be directed to FIGS. 24A-B, which illustrate an enclosure or covering 2400 for an individual CNC machine. The enclosure 2400 beneficially reduces the noise generated during a polishing and/or repair process. The enclosure 2400 may be constructed from any suitable materials, such as plastic, polyvinylchloride, acrylic, etc. Further, the enclosure 2400 may include one or more grooves for lights, cables, wires, or other accessories.

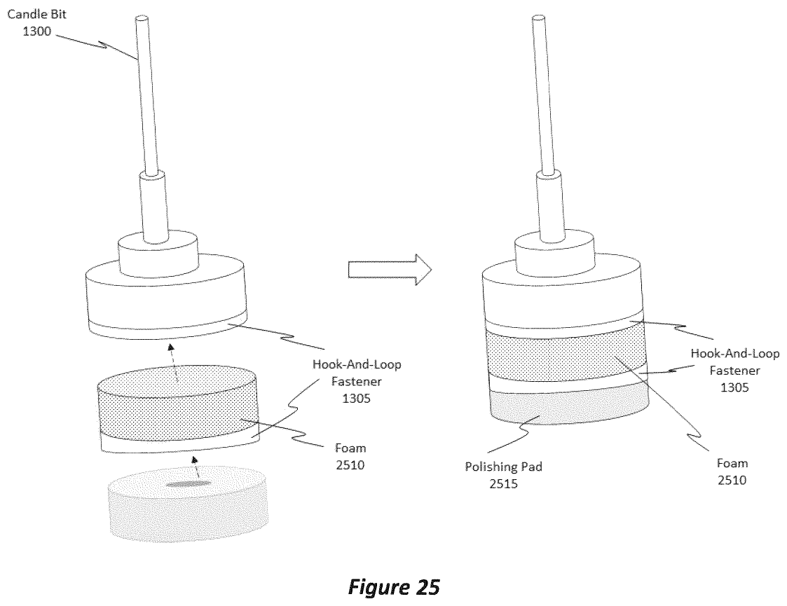

FIG. 25 shows a variation of the candle bit 1300 from FIG. 13, which includes a hook-and-loop fastener 1305, as well as a foam 2510 and polishing pad 2515 (any other type of applicator can be used as well, such as a wipe or brush). Here, the foam 2510 can be connected or fastened to the candle bit 1300 via the hook-and-loop fastener 1305. In some cases, the hook-and-loop fastener 1305 is stitched to the foam 2510. Beneficially, stitching the hook-and-loop fastener 1305 to the foam 2510 ensures the hook-and-loop fastener 1305 stays attached to the foam 2510 during a polishing process, as adhesives may break down due to heat generated during the polishing process. This also ensures the foam 2510 stays attached to the candle bit 1300 (via the hook-and-loop fastener 1305) during the polishing process. In some cases, the foam 2510 is constructed from an EVA foam, which has good compression and springing characteristics. The foam 2510 constructed from EVA foam beneficially provides a more constant and uniform pressure during a polishing and/or repair process of a device, such as that illustrated in FIGS. 14A-B and 15. This results in a more accurate polishing and/or repair of the device. Additionally, the EVA foam has a “good memory” and is capable of springing back to an original shape after compression during a polishing and/or repair process.

Further, the EVA foam beneficially has a long lifespan and can be used for multiple polishing and/or repair processes. In some cases, the EVA foam may be used for over 100 polishing and/or repair processes. In some cases, the EVA foam may be used for up to 100 polishing and/or repair processes. The EVA foam is also beneficially cheap, providing savings in both costs and materials.

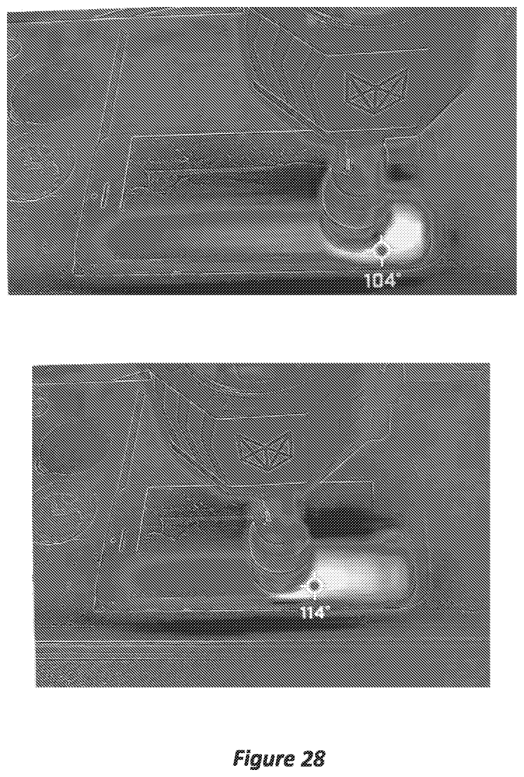

In some embodiments, the foam 2510 is constructed from silicon or another heat resistant material. The foam 2510 may experience an increase in temperature during a polishing and/or repair process. For example, as described with respect to FIG. 28, the surface of the device during a polishing and/or repair process may reach temperatures of approximately 120° F. At such high temperatures, some foams or materials may begin to collapse and degrade. Using a silicon or other heat resistant material beneficially prolongs the lifespan of the foam 2510 and ensures a consistent pressure applied to the surface of a device during a polishing and/or repair process.

The foam 2510 may be separable from the polishing pad 2515, enabling the polishing pad 2515 to be changed out with a fresh polishing pad 2515 after a certain number of polishing and/or repair processes. In some cases, the polishing pad 2515 may be used for over 10 polishing and/or repair processes. In some cases, the polishing pad 2515 may be used for up to 10 polishing and/or repair processes.

In some cases, the polishing pad 2515 may be constructed from a range of 26-32 lb wool felt. In some cases, the polishing pad 2515 is constructed from a range of 30-32 lb wool felt. In some cases, the polishing pad 2515 is constructed from 32 lb wool felt. In some cases, the polishing pad 2515 may be constructed from additional polishing materials, such as silk, microfiber, suede, cotton flannel, etc. In some cases, the polishing pad 2515 may be separably connected to the foam 2510 via a second hook-and-loop fastener 1305. In some cases, the second hook-and-loop fastener 1305 is stitched and adhered to the foam 2510. Beneficially, stitching the second hook-and-loop fastener 1305 to the foam 2510 ensures the second hook-and-loop fastener 1305 stays attached to the foam 2510, which ensures the polishing pad 2515 stays attached to the foam 2510 during a polishing process. Further, stitching the second hook-and-loop fastener 1305 to the foam 2510 avoids problems of glue or other adhesives breaking down due to the generation of heat during a polishing process.

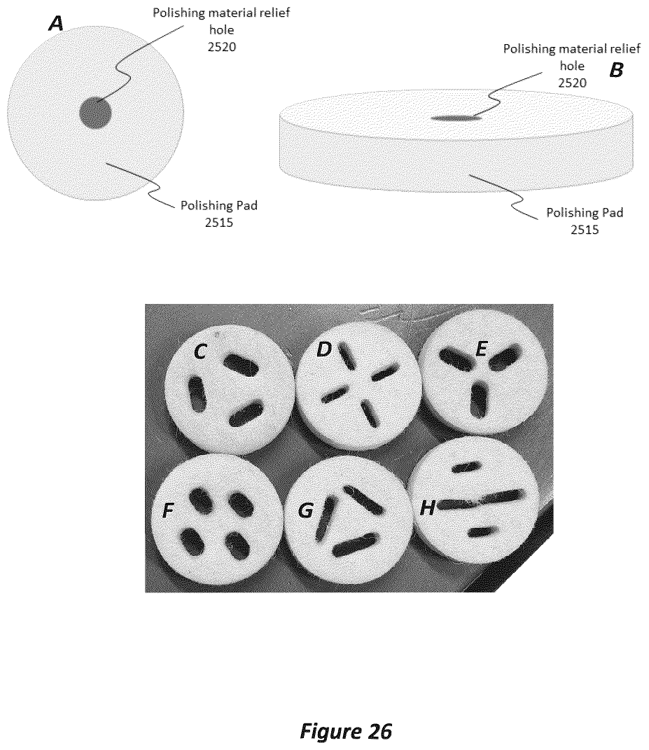

As illustrated in FIGS. 26A-H, the polishing pad 2515 may beneficially include at least one polishing material relief hole 2520, potentially more than one polishing material relief hole 2520, such as 2, 3, 4 or 5. FIGS. 26C-H illustrate varying shapes and placement of the polishing material relief hole 2520 in the polishing pad 2515. The polishing material relief hole 2520 may be a through-hole or may be a pocket. Beneficially, the polishing material relief hole 2520 extends the lifespan of the polishing pad 2515. The polishing material relief hole 2520 receives pilling (little balls of fiber that form on fibrous materials) that builds up from the polishing pad 2515 during a polishing and/or repair process. Ordinarily, the build-up of pilling on the polishing pad 2515 degrades the polishing pad 2515 and impacts the polishing and/or repair process by introducing dust, fibers or potentially new scratches onto the surface of the device being polished and/or repaired. The polishing material relief hole 2520 receives the build-up of pilling from the polishing pad 2515, beneficially preventing dust, fibers or potential new scratches from being introduced to the device during the polishing and/or repair process. By receiving the build-up of pilling from the polishing pad 2515, the polishing material relief hole 2520 extends the lifespan of the polishing pad 2515.

In some cases, using pressure tabs to calibrate a pressure of the candle bit 1300, and/or a polishing pad 2515 mounted on the candle bit 1300, identifies or determines a remaining lifespan for the polishing pad 2515. Briefly, to calibrate the pressure of a polishing pad 2515, the polishing pad 2515 will be lowered by the CNC machine toward the surface of the device to be repaired or polished. One or more pressure tabs are disposed on the surface of the device. The CNC machine will lower the polishing pad 2515 until the polishing pad 2515 contacts the pressure tab.

If the polishing pad 2515 is lowered with adequate pressure, upon contacting the pressure tab the pressure tab will break. If the pressure tab fails to break, the process can be repeated with a higher pressure applied. If the pressure tab continually fails to break, this will indicate to the user and/or the CNC machine that a new polishing pad 2515 needs to be attached to the candle bit 1300. Identifying when a new polishing pad 2515 is necessary beneficially avoids insufficiently polishing and/or repairing scratches on devices in need of polishing and/or repair. Similarly, identifying when a new polishing pad 2515 is necessary beneficially avoids scratching or cracking the screen of a device due to an aberrant application of too much pressure.

FIGS. 27A-B illustrate another example of a platform 2700. The platform 2700 is insertable into, for example, the recessed platform-receiving area 505 shown in FIG. 5. The platform 2700 is also structured to include any number of mounting holes 2710 for securing the platform 2700 to a staging area, such as the staging area depicted in FIGS. 5 and 19B. As illustrated in FIGS. 26A-B, the platform 2700 is structured and shaped to receive a watch device. The platform 2700 may be structured and shaped to receive any type of device, such as tablets.

FIG. 28 illustrates thermal images captured during a polishing and/or repair process where the real-time temperature of the surface of the device may be displayed to an operator. That is, a thermal camera can be included as a part of the system, and the thermal camera can be used to provide data reflecting the temperature of the surface of the device during a polishing process. This data can be used as feedback data to control and refine the polishing process. As illustrated in FIG. 28, the real-time temperature of the surface of the device displayed progresses from 104° F. to 114° F. during the polishing and/or repair process. In some embodiments, the real-time temperature of the surface of the device is communicated to a sensor or computer system providing feedback enabling the system to adjust the pressure and/or speed of rotation of the candle bit 1430 (referring to FIGS. 14A-B).

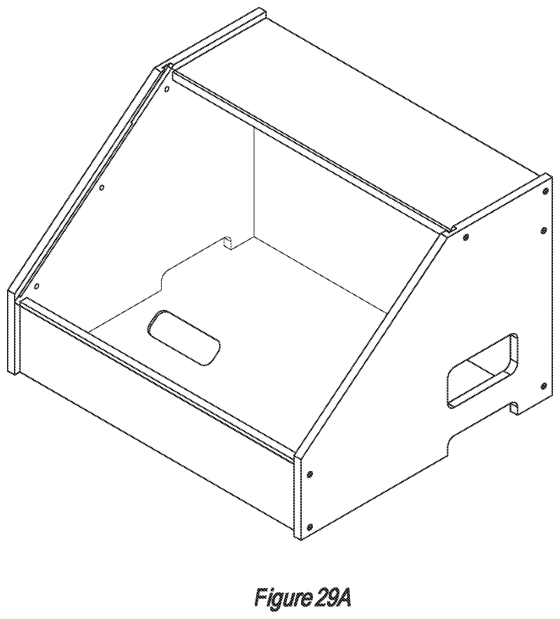

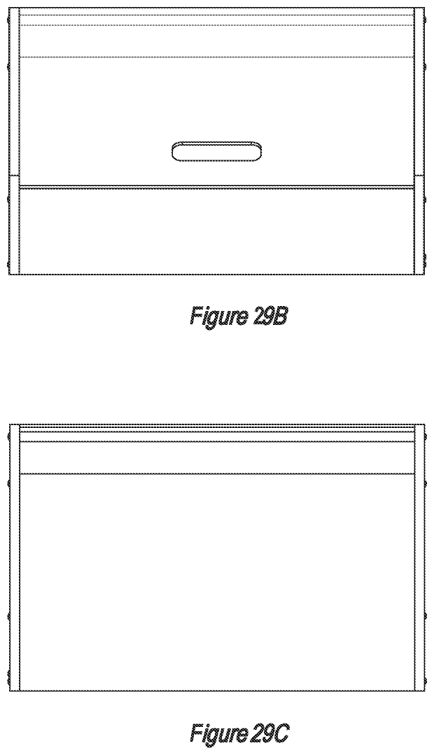

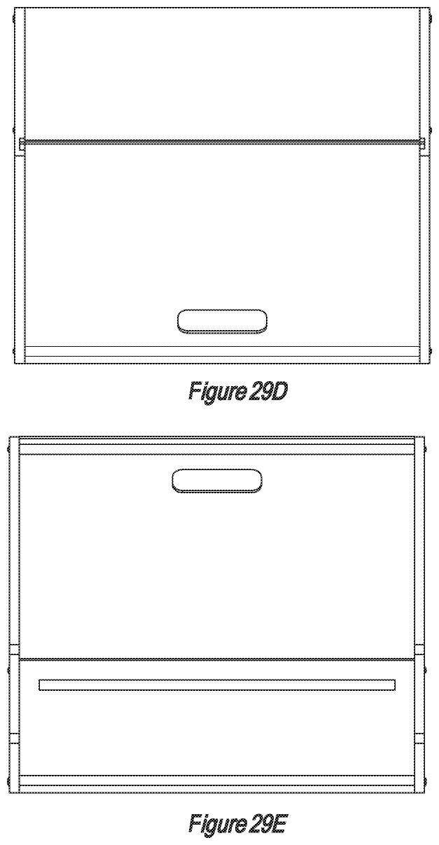

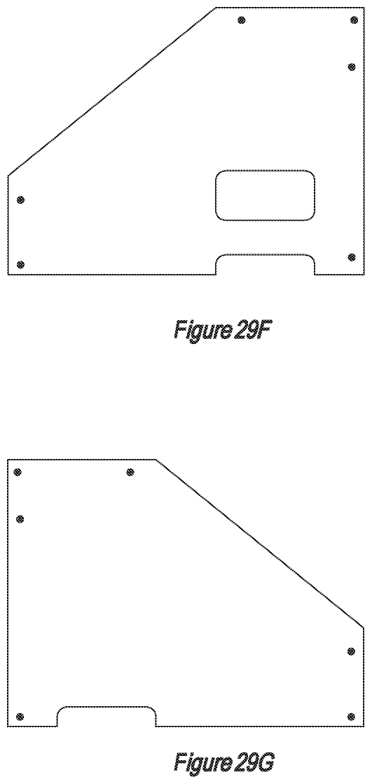

FIG. 29A is a front perspective view of one embodiment of an enclosure. FIGS. 29B-C are front and back views of one embodiment of the enclosure. FIGS. 29D-E are top and bottom views of one embodiment of the enclosure. FIGS. 29F-G are left and right views of one embodiment of the enclosure.

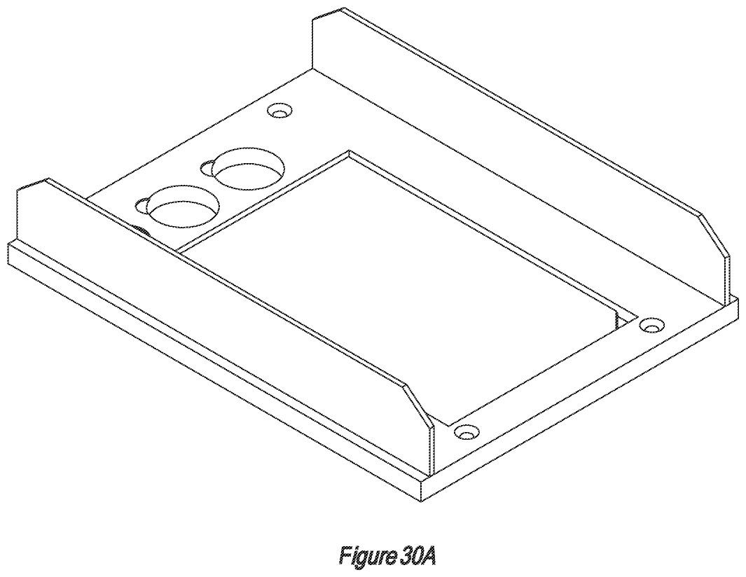

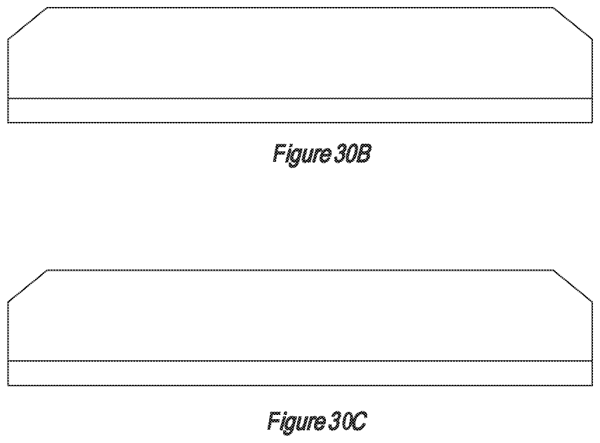

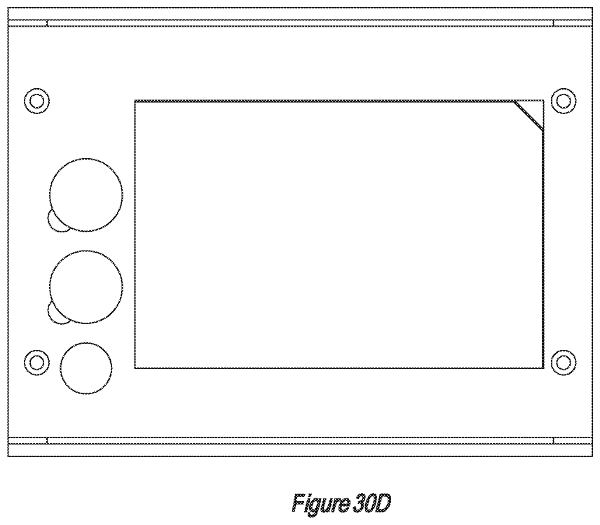

FIG. 30A is a front perspective view of one embodiment of a staging area. FIGS. 30B-C are front and back views of one embodiment of the staging area. FIGS. 30D-E are top and bottom views of one embodiment of the staging area. FIGS. 30F-G are left and right views of one embodiment of the staging area.

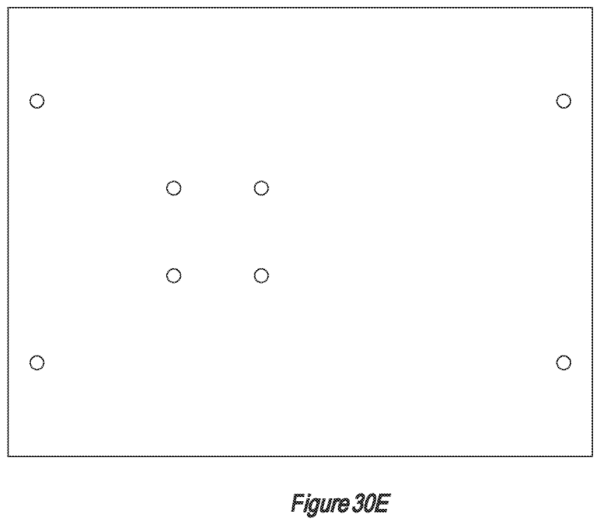

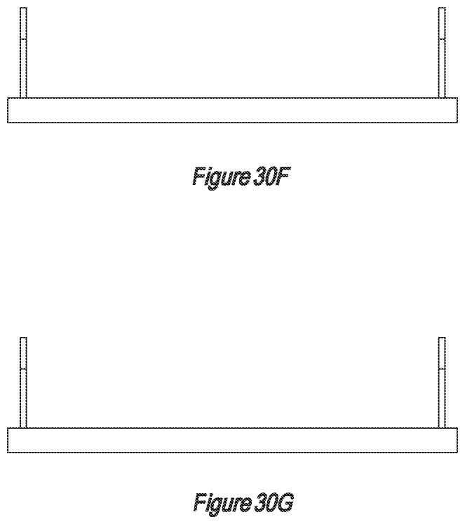

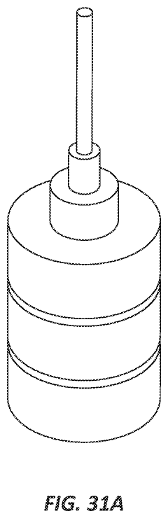

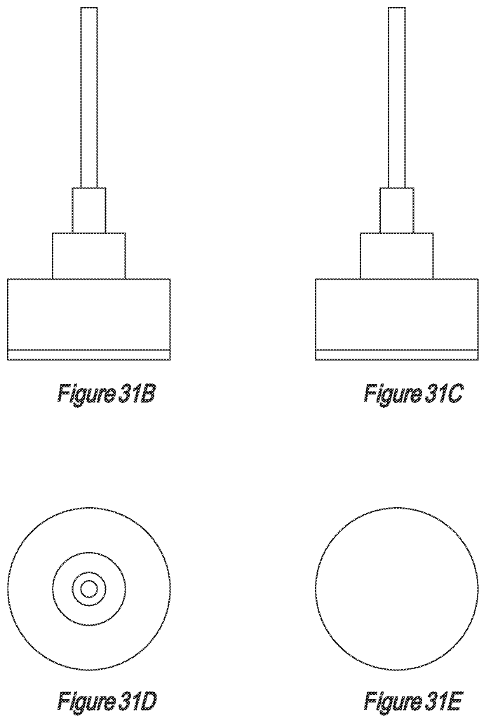

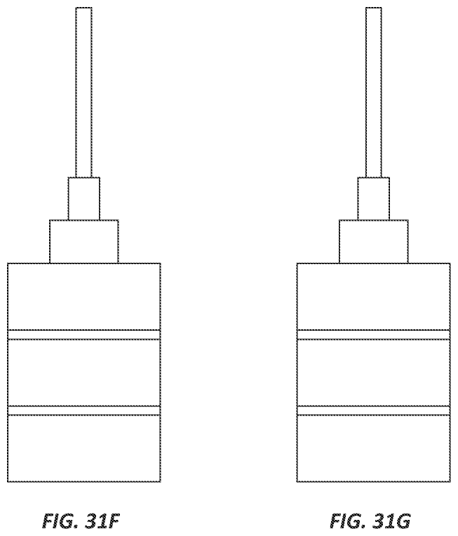

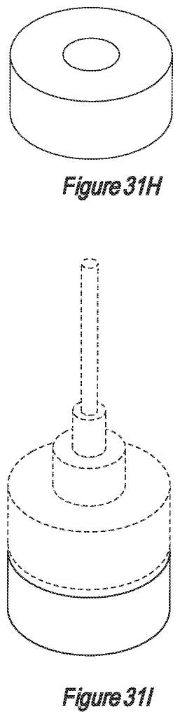

FIG. 31A is a front perspective view of one embodiment of a candle bit with an applicator. FIGS. 3B-C are left and right views of one embodiment of the candle bit with an applicator. FIGS. 31D-E are top and bottom views of one embodiment of the candle bit with an applicator. FIGS. 31F-G are front and back view of one embodiment of the candle bit with an applicator. FIG. 31H is a bottom perspective view of the applicator of the candle bit. FIG. 31I is a side perspective view of the candle bit with an applicator.

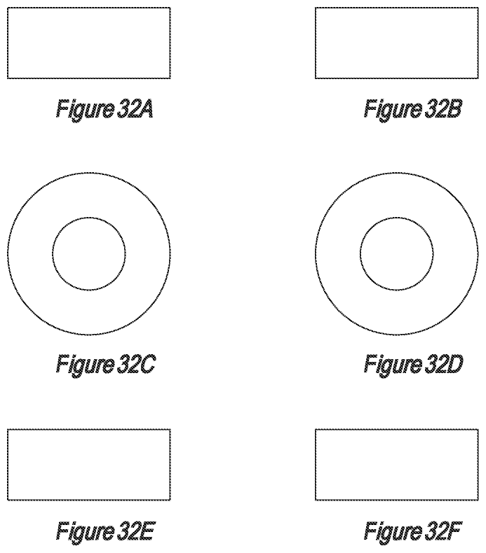

FIGS. 32A-B are left and right views of one embodiment of a polishing pad. FIGS. 32C-D are top and bottom views of one embodiment of the polishing pad. FIGS. 32E-F are front and back views of one embodiment of the polishing pad.

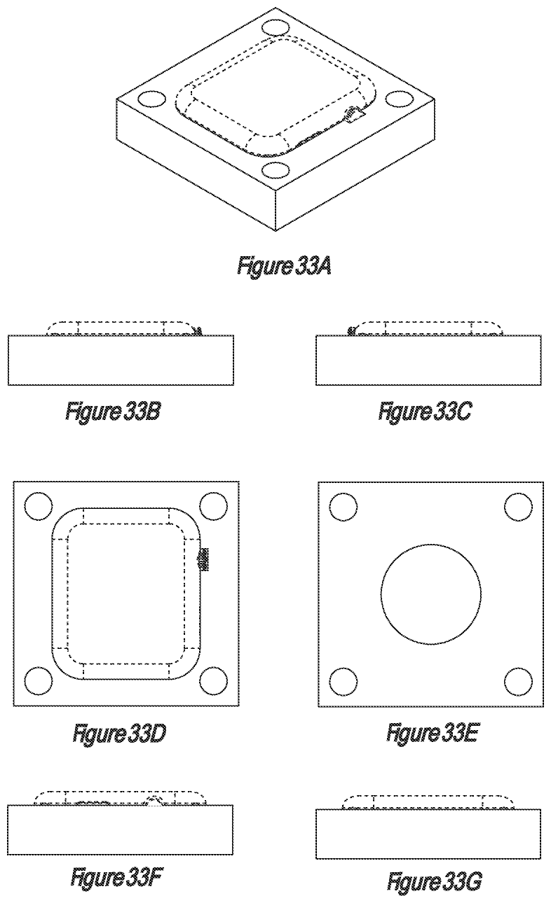

FIG. 33A is a front perspective view of one embodiment of a platform configured to house a watch, as discussed previously. FIGS. 33B-C are left and right views of one embodiment of the platform. FIGS. 33D-E are top and bottom views of one embodiment of the platform. FIGS. 33F-G are front and back view of one embodiment of the platform.

### Example Computer/Computer systems

Attention will now be returned to FIG. 23 which illustrates an example computer system 2300 that may include and/or be used to perform any of the operations described herein. For instance, the computer system 2300 can be the computer system 105 described in FIGS. 1A and 1B.

Computer system 2300 may take various different forms. For example, computer system 2300 may be embodied as a tablet 2300A, a desktop or a laptop 2300B, a wearable device 2300C, a mobile device, or a standalone device. The ellipsis 2300D demonstrates how the computer system 2300 can take on other form factors as well. Computer system 2300 may also be a distributed system that includes one or more connected computing components/devices that are in communication with computer system 2300.

In its most basic configuration, computer system 2300 includes various different components. FIG. 23 shows that computer system 2300 includes one or more processor(s) 2305 (aka a “hardware processing unit”) and storage 2310.

Regarding the processor(s) 2305, it will be appreciated that the functionality described herein can be performed, at least in part, by one or more hardware logic components (e.g., the processor(s) 2305). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “engine,” or “algorithm” (e.g., machine learning algorithm) can refer to hardware processing units or to software objects, routines, or methods that may be executed on computer system 2300. The different components, modules, engines, and services described herein may be implemented as objects or processors that execute on computer system 2300 (e.g. as separate threads).

Storage 2310 may be physical system memory, which may be volatile, non-volatile, or some combination of the two. The term “memory” may also be used herein to refer to non-volatile mass storage such as physical storage media. If computer system 2300 is distributed, the processing, memory, and/or storage capability may be distributed as well.

Storage 2310 is shown as including executable instructions 2315. The executable instructions 2315 represent instructions that are executable by the processor(s) 2305 of computer system 2300 to perform the disclosed operations, such as those described in the various methods.

The disclosed embodiments may comprise or utilize a special-purpose or general-purpose computer including computer hardware, such as, for example, one or more processors (such as processor(s) 2305) and system memory (such as storage 2310), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that carry computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2300 may also be connected (via a wired or wireless connection) to external sensors (e.g., one or more remote cameras) or devices via a network 2320. For example, computer system 2300 can communicate with any number devices (e.g., a CNC machine) or cloud services to obtain or process data. In some cases, network 2320 may itself be a cloud network. Furthermore, computer system 2300 may also be connected through one or more wired or wireless networks 2320 to remote/separate computer systems(s) that are configured to perform any of the processing described with regard to computer system 2300.

A “network,” like network 2320, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2300 will include one or more communication channels that are used to communicate with the network 2320. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

### Listing of Exemplary or Illustrative Embodiments

One or more embodiments or aspects of the present disclose include a computer system, comprising:
a computer numerical control (CNC) machine equipped with a candle bit and a staging area, wherein:
   the candle bit includes an end-mounted applicator, and
   the staging area includes a reservoir that includes a paste;
one or more processors; and
one or more computer-readable hardware storage devices that store instructions that are executable by the one or more processors to cause the computer system to at least:
   move the end-mounted applicator, which is mounted on the candle bit, to a position above the reservoir;
   cause the end-mounted applicator to be dipped into the paste;
   cause the end-mounted applicator to be removed from the reservoir;
   move the end-mounted applicator to a home position relative to a device that is to be polished, wherein the device is disposed on the staging area;
   rotate the candle bit at a predetermined rate such that the end-mounted applicator also rotates; and
   cause the rotating end-mounted applicator to contact a surface of the device while the rotating end-mounted applicator moves in accordance with a predetermined pattern such that the rotating end-mounted applicator polishes the surface of the device using the paste.

Additional embodiments or aspects of the present disclose include the computer system:
wherein the paste is a scratch removing paste, and wherein polishing the surface with the scratch removing paste results in a threshold amount of surface material being removed from the surface to remove a scratch on the surface;
wherein the threshold amount of surface material that is removed is between 1 nanometer (nm) of surface material and 6 nm of surface material;
wherein the predetermined rate that the candle bit is rotated is between 1,000 RPM and 2,500 RPM;
wherein the end-mounted applicator is affixed to the candle bit via a hook-and-loop fastener connection;
wherein the staging area includes a platform comprising free-floating mounts, and wherein the device is positioned on the free-floating mounts of the platform such that the device is elevated in a floating manner;
wherein the home position is a predetermined position that is selected based on known attributes of the device;
wherein the home position is a dynamically determined position based on an identified feature of the device;
wherein execution of the instructions further causes the computer system to: determine a make and model of the device; based on the determined make and model of the device, determine dimensions of the device; and use the dimensions to determine the predetermined pattern by which the rotating end-mounted applicator polishes the surface of the device;
wherein moving the rotating end-mounted applicator in accordance with the predetermined pattern to cause the end-mounted applicator to polish the surface of the device using the paste includes: causing the rotating end-mounted applicator to follow a first pattern to apply the paste to at least a selected portion of the surface of the device; and after completion of the rotating end-mounted applicator following the first pattern, causing the rotating end-mounted applicator to follow a second pattern to further polish the surface of the device by moving the rotating end-mounted applicator to various positions across the surface; and/or
wherein execution of the instructions further causes the computer system to calibrate a z zero of the device.

Additional embodiments or aspects of the present disclose include a computer system, comprising: a computer numerical control (CNC) machine equipped with a candle bit and a staging area, wherein:
the candle bit includes an end-mounted applicator,
a paste is coated on the end-mounted applicator, and
a device is disposed on a free-floating mount of a platform of the staging area;
   one or more processors; and
   one or more computer-readable hardware storage devices that store instructions that are executable by the one or more processors to cause the computer system to at least:
move the candle bit to a home position relative to the device, which is to be polished using the paste coated on the end-mounted applicator;
rotate the candle bit at a predetermined rate such that the end-mounted applicator is also rotated;
cause the end-mounted applicator to contact a surface of the device, resulting in the paste contacting the surface; and
move the rotating candle bit in accordance with a predetermined pattern to cause the end-mounted applicator, which is coated with the paste, to polish the surface of the device.

Additional embodiments or aspects of the present disclose include the computer system:
wherein the end-mounted applicator is pre-configured to be coated with the paste;
wherein the end-mounted applicator is dipped in a container comprising the paste to coat the end-mounted applicator with the paste;
wherein the home position is predetermined based on determined dimensions of the device;
wherein the home position is determined using a sensor that senses a feature of the device;
wherein the home position is determined using a z-finder puck that determines a z-height of the device;
wherein the instructions further cause the computer system to calibrate a z zero of the device;
wherein the z zero of the device is calibrated with a z-finder puck that determines a z-height of the device; and/or
wherein: the CNC machine moves the candle bit and/or the staging platform in an x dimension and a y dimension, the device is positioned on a staging platform, and the CNC machine moves the candle bit and/or staging platform in a z-dimension.

Additional embodiments or aspects of the present disclose include a method for polishing a surface of a device, said method comprising:
coating an applicator with a paste using a computer numerical control (CNC) machine, wherein the applicator is attached to a candle bit of the CNC machine, and wherein the device is disposed on a staging area of the CNC machine;
moving the applicator and/or the staging area using the CNC machine such that the applicator is positioned above a selected area of the surface of the device;
rotating the applicator at a predetermined rate using the CNC machine;
moving the applicator and/or the staging area using the CNC machine to cause the applicator to contact the surface; and moving the applicator and/or the staging area using the CNC machine in accordance with a predetermined pattern, which pattern is selected to enable the paste and the applicator to polish the surface of the device, including a scratch on the surface.

Additional embodiments or aspects of the present disclose include the method, wherein coating the applicator with the paste is performed by using the CNC machine to dip the applicator into a container comprising the paste such that the applicator is coated with the paste.
wherein the CNC machine moves the applicator in an x-y plane, and wherein the CNC machine moves the applicator and/or the staging area in a z-dimension;
wherein polishing the surface of the device using the paste and the applicator is performed by removing a selected amount of material from the surface using the paste;
further comprising finding at least one z zero of the device;
further comprising removing an oleophobic coating present on the surface of the device;
further comprising applying an oleophobic coating to the surface of the device; further comprising calibrating a pressure of the applicator and monitoring the pressure of the applicator during movement of the applicator and/or the staging area in accordance with the predetermined pattern;
wherein calibrating the pressure of the applicator comprises: lowering the applicator toward a pressure tab disposed on the surface of the device; contacting a first portion of the pressure tab with the applicator, where the applicator contacts the first portion with a downward force; and tugging a second portion of the pressure tab, wherein a neck of the pressure tab will break when the downward force is sufficient for polishing the surface of the device;
further comprising monitoring a temperature of the surface of the device during movement of the applicator and/or the staging area in accordance with the predetermined pattern; and/or further comprising storing the predetermined pattern to a profile in a local or remote database.

Additional embodiments or aspects of the present disclose include a method for polishing a surface of a device, said method comprising:
coating an applicator with a pre-treatment solution using a computer numerical control (CNC) machine, wherein the applicator is attached to a candle bit of the CNC machine, and wherein the device is disposed on a staging area of the CNC machine;
moving the applicator and/or the staging area using the CNC machine such that the applicator is positioned above a selected area of the surface of the device;
rotating the applicator at a first predetermined rate using the CNC machine;
moving the applicator and/or the staging area using the CNC machine to cause the applicator to contact the surface;
moving the applicator and/or the staging area using the CNC machine in accordance with a first predetermined pattern, which first pattern is selected to enable the pre-treatment solution and the applicator to remove an oleophobic coating on the surface of the device;
coating a second applicator with a paste using a computer numerical control (CNC) machine;
moving the second applicator and/or the staging area using the CNC machine such that the second applicator is positioned above a selected area of the surface of the device;
rotating the second applicator at a second predetermined rate using the CNC machine;
moving the second applicator and/or the staging area using the CNC machine to cause the applicator to contact the surface;
moving the second applicator and/or the staging area using the CNC machine in accordance with a second predetermined pattern, which second pattern is selected to enable the paste and the second applicator to polish the surface of the device, including a scratch on the surface;
coating a third applicator with an oleophobic coating using a computer numerical control (CNC) machine;
moving the third applicator and/or the staging area using the CNC machine such that the third applicator is positioned above a selected area of the surface of the device;
rotating the third applicator at a third predetermined rate using the CNC machine;
moving the third applicator and/or the staging area using the CNC machine to cause the third applicator to contact the surface; and
moving the third applicator and/or the staging area using the CNC machine in accordance with a third predetermined pattern, which third pattern is selected to enable the third applicator to apply the oleophobic coating on the surface of the device.

Additional embodiments or aspects of the present disclose include the computer system,
wherein the applicator, the second applicator, and the third applicator are the same;
wherein the applicator, the second applicator, and the third applicator are different applicators;
wherein the first predetermined pattern, the second predetermined pattern, and the third predetermined pattern are the same;
wherein the first predetermined pattern, the second predetermined pattern, and the third predetermined pattern are different;
further comprising detecting whether the oleophobic coating has been fully removed from the screen of the device;
wherein the applicator and/or the CNC machine is equipped with a sensor configured to detect whether the oleophobic coating has been fully removed from the screen of the device;
wherein the pre-treatment solution is the same as the paste;
further comprising finding at least one z zero of the device; and/or
further comprising automatically adjusting a pressure or rotation rate of the applicator based on the at least one z zero of the device.

Additional embodiments or aspects of the present disclose include a kit for polishing and/or repairing one or more scratches on a surface of a device, the kit comprising:
one or more floating mounts;
a polishing paste;
a plurality of polishing pads;
a pre-treatment solution;
an oleophobic coating; and
a memory storage device containing executable instructions that configure a CNC machine to polish and/or repair the one or more scratches on the surface of the device.

Additional embodiments or aspects of the present disclose include the kit,
wherein the pre-treatment solution comprises pre-soaked sheets for removing an oleophobic coating from the surface of the device prior to polishing and/or repairing the one or more scratches on the surface of the device; and/or
wherein the one or more floating mounts comprise silicon strips, rubber strips, grip tape, or adhesives.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system comprising:
a computer numerical control (CNC) machine equipped with a candle bit and a staging area, wherein:
the candle bit includes an end-mounted applicator, and
the staging area includes a reservoir that includes a paste;
one or more processors; and
one or more computer-readable hardware storage devices that store instructions that are executable by the one or more processors to cause the computer system to at least:
move the end-mounted applicator, which is mounted on the candle bit, to a position above the reservoir;
cause the end-mounted applicator to be dipped into the paste;
cause the end-mounted applicator to be removed from the reservoir;
move the end-mounted applicator to a home position relative to a device that is to be polished, wherein the device is disposed on the staging area;
rotate the candle bit at a predetermined rate such that the end-mounted applicator also rotates; and
cause the rotating end-mounted applicator to contact a surface of the device while the rotating end-mounted applicator moves in accordance with a predetermined pattern such that the rotating end-mounted applicator polishes the surface of the device using the paste.

2. The computer system of claim 1, wherein the paste is a scratch removing paste, and wherein polishing the surface with the scratch removing paste results in a threshold amount of surface material being removed from the surface to remove a scratch on the surface.

3. The computer system of claim 2, wherein the threshold amount of surface material that is removed is between 1 nanometer (nm) of surface material and 6 nm of surface material.

4. The computer system of claim 1, wherein the predetermined rate that the candle bit is rotated is between 1,000 RPM and 2,500 RPM.

5-7. (canceled)

8. The computer system of claim 1, wherein the home position is a dynamically determined position based on an identified feature of the device.

9. The computer system of claim 1, wherein execution of the instructions further causes the computer system to:
determine a make and model of the device;
based on the determined make and model of the device, determine dimensions of the device; and
use the dimensions to determine the predetermined pattern by which the rotating end-mounted applicator polishes the surface of the device.

10. The computer system of claim 1, wherein moving the rotating end-mounted applicator in accordance with the predetermined pattern to cause the end-mounted applicator to polish the surface of the device using the paste includes:
causing the rotating end-mounted applicator to follow a first pattern to apply the paste to at least a selected portion of the surface of the device; and
after completion of the rotating end-mounted applicator following the first pattern, causing the rotating end-mounted applicator to follow a second pattern to further polish the surface of the device by moving the rotating end-mounted applicator to various positions across the surface.

11. The computer system of claim 1, wherein execution of the instructions further causes the computer system to calibrate a z zero of the device.

12. A computer system comprising:
a computer numerical control (CNC) machine equipped with a candle bit and a staging area, wherein:
the candle bit includes an end-mounted applicator,
a paste is coated on the end-mounted applicator, and
a device is disposed on a free-floating mount of a platform of the staging area;
one or more processors; and
one or more computer-readable hardware storage devices that store instructions that are executable by the one or more processors to cause the computer system to at least:
move the candle bit to a home position relative to the device, which is to be polished using the paste coated on the end-mounted applicator;
rotate the candle bit at a predetermined rate such that the end-mounted applicator is also rotated;
cause the end-mounted applicator to contact a surface of the device, resulting in the paste contacting the surface; and
move the rotating candle bit in accordance with a predetermined pattern to cause the end-mounted applicator, which is coated with the paste, to polish the surface of the device.

13-14. (canceled)

15. The computer system of claim 12, wherein the home position is predetermined based on determined dimensions of the device.

16-19. (canceled)

20. The computer system of claim 12, wherein:
the CNC machine moves the candle bit and/or the staging platform in an x dimension and a y dimension,
the device is positioned on a staging platform, and
the CNC machine moves the candle bit and/or staging platform in a z-dimension.

21. A method for polishing a surface of a device, said method comprising:
coating an applicator with a paste using a computer numerical control (CNC) machine, wherein the applicator is attached to a candle bit of the CNC machine, and wherein the device is disposed on a staging area of the CNC machine;
moving the applicator and/or the staging area using the CNC machine such that the applicator is positioned above a selected area of the surface of the device;
rotating the applicator at a predetermined rate using the CNC machine;
moving the applicator and/or the staging area using the CNC machine to cause the applicator to contact the surface; and
moving the applicator and/or the staging area using the CNC machine in accordance with a predetermined pattern, which pattern is selected to enable the paste and the applicator to polish the surface of the device, including a scratch on the surface.

22. The method of claim 21, wherein coating the applicator with the paste is performed by using the CNC machine to dip the applicator into a container comprising the paste such that the applicator is coated with the paste.

23. The method of claim 21, wherein the CNC machine moves the applicator in an x-y plane, and wherein the CNC machine moves the applicator and/or the staging area in a z-dimension.

24. The method of claim 21, wherein polishing the surface of the device using the paste and the applicator is performed by removing a selected amount of material from the surface using the paste.

25. The method of claim 21, further comprising finding at least one z zero of the device.

26. The method of claim 21, further comprising removing an oleophobic coating present on the surface of the device.

27. The method of claim 21, further comprising applying an oleophobic coating to the surface of the device.

28. The method of claim 21, further comprising calibrating a pressure of the applicator and monitoring the pressure of the applicator during movement of the applicator and/or the staging area in accordance with the predetermined pattern.

29-30. (canceled)

31. The method of claim 21, further comprising storing the predetermined pattern to a profile in a local or remote database.

32-44. (canceled)
